(19) United States
(12) Patent Application Publication
(10) Pub. No.: US 2023/0199898 A1
(43) Pub. Date: Jun. 22, 2023

(54) METHOD AND DEVICE USED IN COMMUNICATION NODE FOR WIRELESS COMMUNICATION

(71) Applicants: Qiaoling YU, SHANGHAI (CN); Xiaobo ZHANG, SHANGHAI (CN)

(72) Inventors: Qiaoling YU, SHANGHAI (CN); Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 18/110,902

(22) Filed: Feb. 17, 2023

Related U.S. Application Data
(63) Continuation of application No. PCT/CN2022/079550, filed on Mar. 7, 2022.

(30) Foreign Application Priority Data
Mar. 9, 2021 (CN) 202110253932.7

(51) Int. Cl. H04W 76/27

(52) U.S. Cl. CPC H04W 76/27

(57) ABSTRACT

A method and a device in a communication node for wireless communications. A communication node receives a first signaling, the first signaling being used to determine a first Timing Advance; and determines according to at least an RRC state whether a first buffer is flushed at a first time; a time interval from the action of receiving the first signaling till the first time is larger than or equal to a first expiration value of a first timer; not any message that indicates a Timing Advance is received from the action of receiving the first signaling till the first time; the action of determining according to at least an RRC state whether a first buffer is flushed at a first time comprises: flushing the first buffer at the first time when an RRC Connected state is kept from the action of receiving the first signaling till the first time.

### CROSS REFERENCE TO RELATED APPLICATIONS

This application is the continuation of the international patent application No.PCT/CN2022/079550, filed on Mar. 7,2022, which claims the priority benefit of Chinese Patent Application No.202110253932.7 filed on Mar. 9,2021, the full disclosure of which is incorporated herein by reference.

### BACKGROUND

### TechnicaL Field

The present application relates to transmission methods and devices in wireless communication systems, and in particular to a method and a device for transmission of small-data traffics.

### Related Art

New Radio (NR) supports Radio Resource Control_INACTIVE (RRC_INACTIVE) State till the 3GPP Rel-16 in which data transmission is no longer supported in an RRC_INACTIVE State. When a User Equipment (UE) in an RRC_INACTIVE state has infrequent small data packets needed to be transmitted in a periodic or aperiodic manner, it shall resume connection in the first place, that is to shift to an RRC_CONNECTED state, and won't switch back to the RRC_INACTIVE state until data transmission is completed. As was decided at the 3GPP RAN#86 meetings, a Work Item (WI) of “NR INACTIVE state Small Data Transmission (SDT)” will be conducted to study the technique of small data transmission in an RRC_INACTIVE state, including transmitting uplink data on pre-configured Physical Uplink Shared Channel (PUSCH) resources, or carrying data by means of either a Message 3 (Msg3) or a Message B (MsgB) in a Random Access (RA) procedure.

### SUMMARY

In the RRC_CONNECTED state the base station maintains a Timing Advance (TA) of the UE, while in the RRC_INACTIVE or RRC_IDLE state, upon reception of a TA Command, it adjusts a TA according to the TA Command and starts or re-starts a timeAlignmentTimer, when the timeAlignmentTimer is expired, if an SDT is being performed, the expiration will influence the current SDT transmission, therefore, the enhancement on the timeAlignmentTimer is inevitable.

To address the above problem, the present application provides a solution. Although the description above only takes NR scenarios as an example; the present application is also applicable to scenarios such as Long Term Evolution (LTE) or NarrowBand Internet of Things (NB-IoT), where similar technical effects can be achieved. Additionally, the adoption of a unified solution for various scenarios contributes to the reduction of hardcore complexity and costs.

In one embodiment, interpretations of the terminology in the present application refer to definitions given in the 3GPP TS 36 series.

In one embodiment, interpretations of the terminology in the present application refer to definitions given in the 3GPP TS 38 series.

In one embodiment, interpretations of the terminology in the present application refer to definitions given in the 3GPP TS 37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:

receiving a first signaling, the first signaling being used to determine a first Timing Advance; and determining according to at least an RRC state whether a first buffer is flushed at a first time;

herein, a time interval from the action of receiving the first signaling till the first time is larger than or equal to a first expiration value of a first timer; not any message that indicates a Timing Advance is received from the action of receiving the first signaling till the first time; the action of determining according to at least an RRC state whether a first buffer is flushed at a first time comprises:

flushing the first buffer at the first time when an RRC Connected state is kept from the action of receiving the first signaling till the first time; or

not flushing the first buffer at the first time when an RRC Inactive state is kept from the action of receiving the first signaling till the first time.

In one embodiment, a problem to be solved in the present application includes: in the current protocol, the base station cannot maintain the TA when the UE is in an RRC_INACTIVE state.

In one embodiment, a problem to be solved in the present application includes: flushing a first buffer will affect the current transmission when the first timer is expired.

In one embodiment, characteristics of the above method include: whether the first buffer is flushed is determined according to an RRC state.

In one embodiment, characteristics of the above method include: whether the first buffer is flushed is related to an RRC state.

In one embodiment, characteristics of the above method include: flushing the first buffer at the first time when an RRC Connected state is kept from the action of receiving the first signaling till the first time.

In one embodiment, characteristics of the above method include: not flushing the first buffer at the first time when an RRC Inactive state is kept from the action of receiving the first signaling till the first time.

In one embodiment, an advantage of the above method includes preventing the impact of flushing the first buffer on the current transmission.

In one embodiment, an advantage of the above method includes avoiding triggering of unnecessary operation.

In one embodiment, an advantage of the above method includes increasing the efficiency of transmission.

According to one aspect of the present application, characterized in comprising:

as a response to the action of receiving the first signaling, applying the first Timing Advance, and starting the first timer;

herein, the time while the first timer is running from the action of receiving the first signaling till the first time reaches the first expiration value of the first timer.

According to one aspect of the present application, characterized in comprising:

as a response to the action of receiving a first signaling, dropping starting the first timer.

According to one aspect of the present application, characterized in comprising:

receiving a first message; and, as a response to the action of receiving a first message, starting the first timer;

herein, the first message is used for transition of the RRC state.

According to one aspect of the present application, characterized in comprising:

as a response to the action of receiving a first signaling, starting a second timer; and determining whether the first buffer is flushed at the first time according at least to whether the second timer is running;

herein, the second timer is different from the first timer.

According to one aspect of the present application, characterized in comprising:

as the second timer is running, determining a second expiration value of the first timer according to the second timer as a response to the action of receiving a first message.

According to one aspect of the present application, characterized in comprising:

transmitting a second message set in the RRC Inactive state;

herein, the second message set triggers the first signaling

The present application provides a method in a second node for wireless communications, comprising:

transmitting a first signaling, the first signaling being used to determine a first Timing Advance;

herein, whether a first buffer is flushed at a first time is determined according to at least an RRC state; a time interval from the first signaling being received till the first time is larger than or equal to a first expiration value of a first timer; not any message that indicates a Timing Advance is received from the first signaling being received till the first time; the phrase that whether a first buffer is flushed at a first time is determined according to at least an RRC state comprises:

the first buffer being flushed at the first time when an RRC Connected state is kept from the first signaling being received till the first time; or

the first buffer not being flushed at the first time when an RRC Inactive state is kept from the first signaling being received till the first time.

According to one aspect of the present application, characterized in that as a response to the first signaling being received, the first Timing Advance is applied, and the first timer is started; wherein the time while the first timer is running from the action of receiving the first signaling till the first time reaches the first expiration value of the first timer.

According to one aspect of the present application, characterized in that as a response to the first signaling being received, the first timer is dropped for starting.

According to one aspect of the present application, characterized in comprising:

transmitting a first message;

herein, as a response to the first message being received, the first timer is started; the first message is used for transition of the RRC state.

According to one aspect of the present application, characterized in that as a response to the first signaling being received, a second timer is started; herein, whether the first buffer is flushed at the first time is determined according at least to whether the second timer is running; the second timer is different from the first timer.

According to one aspect of the present application, characterized in that as the second timer is running, a second expiration value of the first timer is determined according to the second timer as a response to the first message being received.

According to one aspect of the present application, characterized in comprising:

receiving a second message set;

herein, the second message set triggers the first signaling; the second message set is transmitted in the RRC Inactive state.

The present application provides a first node for wireless communications, comprising:

a first receiver, receiving a first signaling, the first signaling being used to determine a first Timing Advance; and determining according to at least an RRC state whether a first buffer is flushed at a first time;

herein, a time interval from the action of receiving the first signaling till the first time is larger than or equal to a first expiration value of a first timer; not any message that indicates a Timing Advance is received from the action of receiving the first signaling till the first time; the action of determining according to at least an RRC state whether a first buffer is flushed at a first time comprises:

flushing the first buffer at the first time when an RRC Connected state is kept from the action of receiving the first signaling till the first time; or

not flushing the first buffer at the first time when an RRC Inactive state is kept from the action of receiving the first signaling till the first time.

The present application provides a second node for wireless communications, comprising:

a second transmitter, transmitting a first signaling, the first signaling being used to determine a first Timing Advance;

herein, whether a first buffer is flushed at a first time is determined according to at least an RRC state; a time interval from the first signaling being received till the first time is larger than or equal to a first expiration value of a first timer; not any message that indicates a Timing Advance is received from the first signaling being received till the first time; the phrase that whether a first buffer is flushed at a first time is determined according to at least an RRC state comprises:

the first buffer being flushed at the first time when an RRC Connected state is kept from the first signaling being received till the first time; or

the first buffer not being flushed at the first time when an RRC Inactive state is kept from the first signaling being received till the first time.

In one embodiment, compared with the prior art, the present application is advantageous in the following aspects:

preventing the impact of flushing the first buffer on the current transmission;

avoiding the triggering of unnecessary operation;

increasing the efficiency of transmission.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first signaling according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a flowchart of radio signal transmission according to another embodiment of the present application.

FIG. 7 illustrates a flowchart of radio signal transmission according to another embodiment of the present application.

FIG. 8 illustrates a schematic diagram of dropping starting a first timer upon reception of a first signaling according to one embodiment of the present application.

FIG. 9 illustrates a schematic diagram of starting a first timer upon reception of a first signaling according to one embodiment of the present application.

FIG. 10 illustrates a schematic diagram of starting a second timer upon reception of a first signaling according to one embodiment of the present application.

FIG. 11 illustrates a schematic diagram of starting a first timer and a second timer upon reception of a first signaling according to one embodiment of the present application.

FIG. 12 illustrates a schematic diagram of starting a first timer upon reception of a first message according to one embodiment of the present application.

FIG. 13 illustrates a schematic diagram of starting a first timer upon reception of a first message according to another embodiment of the present application.

FIG. 14 illustrates a schematic diagram of starting a first timer upon reception of a first message according to another embodiment of the present application.

FIG. 15 illustrates a schematic diagram of starting a first timer upon reception of a first message according to another embodiment of the present application.

FIG. 16 illustrates a schematic diagram of determining whether a first buffer is flushed at a first time according to an RRC state and a first parameter set according to one embodiment of the present application.

FIG. 17 illustrates a schematic diagram of a timing relation between uplink and downlink being linked to a first Timing Advance according to one embodiment of the present application.

FIG. 18 illustrates a schematic diagram of determining a second expiration value of a first timer by a second timer according to one embodiment of the present application.

FIG. 19 illustrates a structure block diagram of a processing device used in a first node according to one embodiment of the present application.

FIG. 20 illustrates a structure block diagram of a processing device used in a second node according to one embodiment of the present application.

FIG. 21 illustrates a flowchart of radio signal transmission in which a second message set triggers a first signaling according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

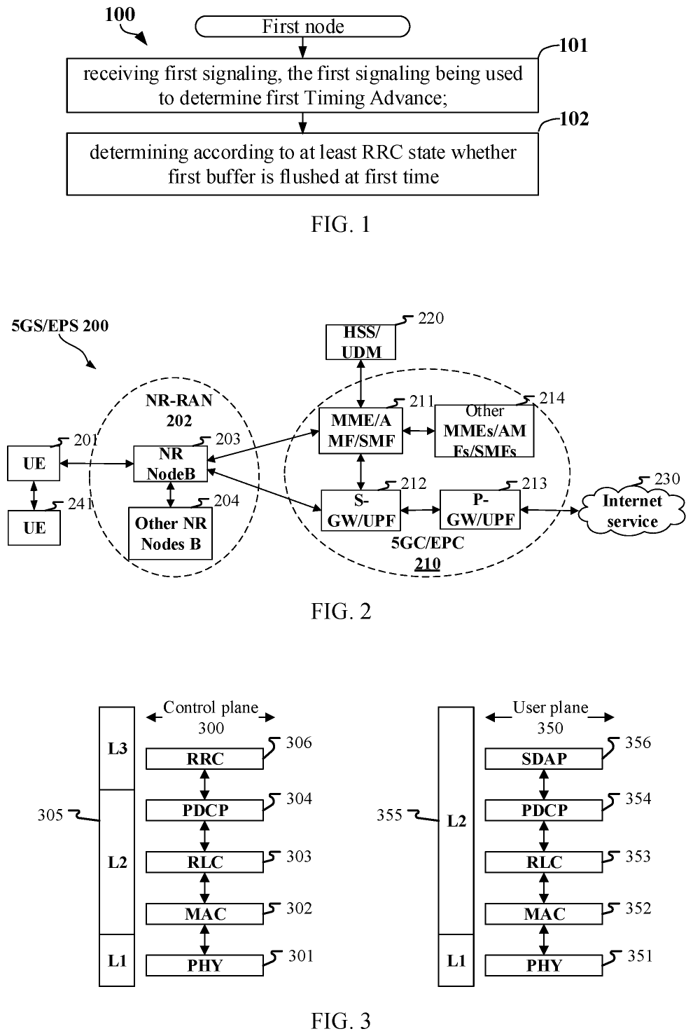

Embodiment 1 illustrates a flowchart of transmission of a first signaling according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first signaling in step 101, the first signaling being used to determine a first Timing Advance; and determines in step 102 according to at least an RRC state whether a first buffer is flushed at a first time; herein, a time interval from the action of receiving the first signaling till the first time is larger than or equal to a first expiration value of a first timer; not any message that indicates a Timing Advance is received from the action of receiving the first signaling till the first time; the action of determining according to at least an RRC state whether a first buffer is flushed at a first time comprises: flushing the first buffer at the first time when an RRC Connected state is kept from the action of receiving the first signaling till the first time; or not flushing the first buffer at the first time when an RRC Inactive state is kept from the action of receiving the first signaling till the first time.

In one embodiment, the first signaling is received in a Small Data Transmission (SDT) procedure.

In one subembodiment, the SDT procedure comprises transmitting a small data packet in an RRC_INACTIVE state.

In one subembodiment, the SDT includes an RRC_INACTIVE Data Transmission (RRC IDT).

In one subembodiment, the SDT procedure comprises transmitting a data packet through a Data Radio Bearer (DRB) in a Radio Resource Control (RRC) Inactive state.

In one subembodiment, the SDT procedure comprises transmitting a data packet through one or more DRBs in an RRC Inactive state.

In one subembodiment, the SDT procedure comprises resuming one or more DRBs in an RRC Inactive state and transmitting a data packet through the one or more DRBs.

In one subembodiment, the SDT procedure comprises transmitting data of DRB(s) on configured resources in an RRC Inactive state.

In one subembodiment, the SDT procedure comprises transmitting a data packet on configured resource blocks in an RRCRelease message or RRCConnectionRelease in an RRC Inactive state.

In one subembodiment, a given timer being running is used to determine the SDT procedure is ongoing.

In one subsidiary embodiment of the above subembodiment, the given timer includes a T319.

In one subsidiary embodiment of the above subembodiment, the name of the given timer includes T3.

In one subsidiary embodiment of the above subembodiment, the given timer includes a Medium Access Control (MAC) layer timer.

In one subsidiary embodiment of the above subembodiment, the given timer includes an RRC layer timer.

In one subsidiary embodiment of the above subembodiment, the given timer includes a Packet Data Convergence Protocol (PDCP) layer timer.

In one embodiment, the SDT includes a first-type SDT.

In one subembodiment, the first-type SDT refers to a SDT initiated by a Random Access (RA) procedure.

In one subembodiment, a first Uplink (UL) Physical Uplink Shared CHannel (PUSCH) of the first-type SDT is transmitted by either a Message 3 (Msg3) or a Message A (MsgA).

In one subembodiment, the first-type SDT refers to transmitting a packet through at least one of a Message 3 (Msg3) or a Message A (MsgA) in a Random Access procedure in the RRC_INACTIVE state, where the packet is associated with one or more DRBs.

In one embodiment, the SDT includes a second-type SDT.

In one subembodiment, the second-type SDT refers to an SDT initiated by preconfigured resources.

In one subembodiment, the second-type SDT refers to transmitting a packet through the reconfigured resources in a RRCRelease in the RRC_INACTIVE state, where the packet is associated with one or more DRBs.

In one subembodiment, the preconfigured resources include Configured Grant.

In one subembodiment, the preconfigured resources include Preconfigured Uplink Resource (PUR).

In one subembodiment, the preconfigured resources include Semi-Persistent Scheduling (SPS).

In one subembodiment, the preconfigured resources include at least one of time-domain resources, frequency-domain resources, spatial-domain resources or code-domain resources.

In one embodiment, a first UL PUSCH of the second-type SDT is transmitted by preconfigured resources.

In one embodiment, the first signaling is not received in the SDT procedure.

In one embodiment, the phrase of the first signaling being used to determine a first Timing Advance comprises that the first signaling indicates the first Timing Advance.

In one embodiment, the phrase of the first signaling being used to determine a first Timing Advance comprises that the first signaling explicitly indicates the first Timing Advance.

In one embodiment, the phrase of the first signaling being used to determine a first Timing Advance comprises that the first signaling implicitly indicates the first Timing Advance.

In one embodiment, the phrase of the first signaling being used to determine a first Timing Advance comprises that the first signaling carries the first Timing Advance.

In one embodiment, the phrase of the first signaling being used to determine a first Timing Advance comprises that the first Timing Advance is calculated according to the first signaling

In one embodiment, the phrase of the first signaling being used to determine a first Timing Advance comprises that the first signaling comprises a first Timing Advance.

In one embodiment, the phrase of the first signaling being used to determine a first Timing Advance comprises that the first signaling determines the first Timing Advance.

In one embodiment, the phrase of the first signaling being used to determine a first Timing Advance comprises that the first Timing Advance is determined according to the first signaling

In one embodiment, the first signaling is received in the RRC Connected state.

In one embodiment, the first signaling is received in the RRC Inactive state.

In one embodiment, the first signaling is transmitted in the RRC Connected state.

In one embodiment, the first signaling is transmitted in the RRC Inactive state.

In one embodiment, the first signaling is transmitted via an air interface.

In one embodiment, the first signaling is transmitted via an antenna port.

In one embodiment, the first signaling is transmitted via an upper layer signaling

In one embodiment, the first signaling is transmitted via a higher layer signaling

In one embodiment, the first signaling comprises a Downlink (DL) signal.

In one embodiment, the first signaling comprises a Sidelink (SL) signal.

In one embodiment, the first signaling comprises an RRC message.

In one embodiment, the first signaling comprises all or part of Information Elements (IEs) in an RRC message.

In one embodiment, the first signaling comprises all or part of fields of an IE in an RRC message.

In one embodiment, the first signaling comprises a physical-layer signaling

In one embodiment, the first signaling comprises a MAC Protocol Data Unit (PDU).

In one embodiment, the first signaling comprises a MAC sub-PDU.

In one embodiment, the first signaling comprises a MAC sub-header.

In one embodiment, the first signaling comprises a MAC Control Element (CE).

In one embodiment, the first signaling comprises a Random Access Response (RAR).

In one embodiment, the first signaling comprises a MAC RAR.

In one embodiment, the first signaling comprises a fallbackRAR.

In one embodiment, the first signaling comprises a successRAR.

In one embodiment, the first signaling comprises a Timing Advance Command MAC CE.

In one embodiment, the first signaling comprises an Absolute Timing Advance Command MAC CE.

In one embodiment, the first signaling comprises a Timing Delta MAC CE.

In one embodiment, the first signaling comprises a field in a MAC CE.

In one embodiment, the first signaling comprises a field in an RAR, the RAR including MAC RAR, or fallbackRAR or successRAR.

In one embodiment, the first signaling comprises a Timing Advance Command field.

In one embodiment, the first signaling is a Timing Advance Command field.

In one embodiment, the first signaling comprises an RRC message.

In one embodiment, the first signaling comprises one field in an RRC message.

In one embodiment, the first signaling comprises one IE in an RRC message.

In one embodiment, the first signaling comprises a positive integer number of bit(s).

In one embodiment, the first signaling is of a size of 6 bits.

In one embodiment, the first signaling is of a size of 12 bits.

In one embodiment, a field in the first signaling indicates an index value T_{A}, and the index value T_{A} is used for controlling a Timing Adjustment applied for a MAC entity, where the definition of the T_{A} can be found in 3GPP TS 38.321.

In one subembodiment, the index value T_{A} is an integer.

In one subembodiment, the index value T_{A} is an integer no less than 0 and no greater than 63.

In one subembodiment, the index value T_{A} is an integer no less than 0 and no greater than 3846.

In one subembodiment, the first signaling comprises a MAC CE, and the field comprises a Timing Advance Command field, the MAC CE including a Timing Advance Command MAC CE or an Absolute Timing Advance Command MAC CE.

In one subembodiment, the first signaling comprises an RAR, and the field comprises a Timing Advance

Command field, the RAR including one of a MAC RAR or a fallbackRAR or a successRAR.

In one embodiment, the first Timing Advance comprises an amount of the time alignment.

In one embodiment, the first Timing Advance comprises a N_{TA}, where the definition of the N_{TA} can be found in 3GPP TS 38.213.

In one embodiment, the first Timing Advance comprises a N_{TA}T_{C}, where the definition of the N_{TA}T_{C} can be found in 3GPP TS 38.213.

In one embodiment, the first Timing Advance is equal to T_{A}·16·64/2^{μ}.

In one embodiment, the first Timing Advance is equal to N_{TA}=T_{A}·16·64/2^{μ}.

In one embodiment, the first Timing Advance is equal to N_{TA_old}+(T_{A}−31)·16·64/2^{μ}, where N_{TA_old} is an old Timing Advance (TA).

In one embodiment, the first Timing Advance is equal to a product of T_{A}·16·64/2^{μ} and T_{c}.

In one embodiment, the first Timing Advance is equal to a product of N_{TA_old}+(T_{A}−31)·16·64/2^{μ} and T_{c}, where N_{TA_old} denotes a Timing Adjustment in a last timing alignment.

In one embodiment, the first Timing Advance is equal to N_{TA_new}=N_{TA_old}+(T_{A}−31)·16 64/2^{μ}, where N_{TA_new} denotes a present Timing Adjustment, and N_{TA_old} denotes a Timing Adjustment in a last timing alignment.

In one embodiment, the μ is a non-negative integer no greater than 256.

In one embodiment, the μ is one of 0, or 1, or 2, or 3 or 4.

In one embodiment, the μ is related to a sub-carrier spacing (SCS).

In one embodiment, the sub-carrier spacing (SCS) Δf is 2^{μ}·15 kHz.

In one embodiment, the first signaling comprises an index value, the index value being used to determine a timing adjustment.

In one embodiment, the first signaling comprises a timing adjustment.

In one embodiment, the first signaling comprises a positive integer number of T_{c}(s).

In one embodiment, the T_{c} refers to a basic time unit in a New Radio (NR) system.

In one embodiment, the first signaling comprises a positive integer number of millisecond(s).

In one embodiment, the first signaling and the first step-size are used to determine a timing adjustment.

In one embodiment, the first Timing Advance is related to a first step-size.

In one embodiment, the first Timing Advance is an integral multiple of the first step-size, the first step-size comprising 16·64·T_{c}/2^{μ}.

In one embodiment, the phrase of according to at least an RRC state includes only according to the RRC state.

In one embodiment, the phrase of according to at least an RRC state includes according to the RRC state and at least one parameter other than the RRC state.

In one embodiment, the phrase of according to at least an RRC state includes according to the RRC state and a first parameter set.

In one embodiment, the first time comprises a specific instant of time.

In one embodiment, the first time comprises a time interval.

In one embodiment, the first time is related to the processing capability of the first node.

In one embodiment, the first time is related to the Central Processing Unit (CPU) of the first node.

In one embodiment, the first time is related to the crystal oscillator of the first node.

In one embodiment, the first time is provided for simple description, and may have some offset due to the equipment or timing in specific implementation.

In one embodiment, the first time comprises an instant of time when the first timer is expired.

In one embodiment, the first time comprises an instant of time determined by going through a time length equal to the first expiration value of the first timer starting from the action of receiving a first signaling

In one embodiment, the first time comprises an instant of time determined by going through a time length larger than the first expiration value of the first timer starting from the action of receiving a first signaling

In one embodiment, the meaning of flushing includes: to refresh.

In one embodiment, the meaning of flushing includes: to clear up.

In one embodiment, the meaning of flushing includes: to flush.

In one embodiment, the first buffer comprises a Buffer.

In one embodiment, the first buffer comprises an Uplink (UL) Buffer.

In one embodiment, the first buffer comprises a Msg3 Buffer.

In one embodiment, the first buffer comprises a MsgB Buffer.

In one embodiment, the first buffer comprises a soft buffer.

In one embodiment, the first buffer comprises a Hybrid Automatic Repeat reQuest (HARQ) buffer.

In one embodiment, the first buffer comprises any HARQ buffer among all HARQ buffers of all serving cells.

In one embodiment, the first buffer is associated with a MAC entity.

In one embodiment, the first buffer is used for CG-SDT.

In one embodiment, the first buffer is used for SDT.

In one embodiment, the first buffer is used for a first HARQ process.

In one subembodiment, the first HARQ process is a HARQ process.

In one subembodiment, the first HARQ process is associated with a HARQ process identifier.

In one embodiment, the RRC state includes an RRC Connected state.

In one subembodiment, the RRC Connected state includes RRC_CONNECTED state.

In one subembodiment, the RRC Connected state includes a state, in which a 5GC-NG-RAN connection (i.e., C-plane and U-plane) is established for the first node.

In one subembodiment, the RRC Connected state includes a state, in which an Access Stratum (AS) Context of the first node is stored both in the Next Generation Radio Access Network (NG-RAN) and the first node.

In one subembodiment, the RRC Connected state includes a state, with the first node in the state the NG-RAN is aware which cell the first node belongs to.

In one subembodiment, the RRC Connected state includes a state, with the first node in the state the network control includes the mobility of measurement.

In one embodiment, the RRC state includes an RRC Inactive state.

In one subembodiment, the RRC Inactive state includes RRC_INACTIVE state.

In one subembodiment, the RRC Inactive state includes RRC_IDLE state.

In one subembodiment, the RRC Inactive state includes a state, in which the performance of PLMN selection is supported.

In one subembodiment, the RRC Inactive state includes a state, in which the broadcasting of system information is supported.

In one subembodiment, the RRC Inactive state includes a state, in which the mobility of Cell Re-selection is supported.

In one subembodiment, the RRC Inactive state includes a state, in which the Paging of mobile terminating data is initiated by the 5G Core Network (5GC).

In one subembodiment, the RRC Inactive state includes a state, in which Discontinuous Reception (DRX) paged by a Core Network (CN) is configured by a Non Access Stratum (NAS).

In one subembodiment, the RRC Inactive state includes a state, in which paging is initiated by an NG-RAN (that is, RAN Paging).

In one subembodiment, the RRC Inactive state includes a state, in which the RAN-based notification area (RNA) is managed by the NG-RAN.

In one subembodiment, the RRC Inactive state includes a state, in which DRX paged by the RAN is configured by the NG-RAN.

In one subembodiment, the RRC Inactive state includes a state, in which a 5GC-NG-RAN connection (i.e., C-plane and U-plane) is established for the first node.

In one subembodiment, the RRC Inactive state includes a state, in which an Access Stratum (AS) Context of the first node is stored both in the Next Generation Radio Access Network (NG-RAN) and the first node.

In one subembodiment, the RRC Inactive state includes a state, in which the first node NG-RAN knows which RA the UE belongs to.

In one subembodiment, the RRC Inactive state includes a state, in which the first node does not listen over a Physical Downlink Control Channel (PDCCH).

In one subembodiment, the RRC Inactive state includes a state, in which the first node does not perform Radio Resource Management (RRM) measurement.

In one embodiment, the action of determining according to at least an RRC state whether a first buffer is flushed at a first time comprises: determining whether all HARQ buffers of all serving cells are flushed at the first time according to the RRC state, where the first buffer is any one of the said HARQ buffers.

In one embodiment, the action of determining according to at least an RRC state whether a first buffer is flushed at a first time comprises: determining whether a first buffer is flushed at a first time only according to the RRC state.

In one embodiment, the action of determining according to at least an RRC state whether a first buffer is flushed at a first time comprises: whether a first buffer is flushed at a first time is related to the RRC state.

In one embodiment, the action of determining according to at least an RRC state whether a first buffer is flushed at a first time comprises: flushing the first buffer at the first time when an RRC Connected state is kept from the action of receiving a first signaling till the first time.

In one embodiment, the action of determining according to at least an RRC state whether a first buffer is flushed at a first time comprises: not flushing the first buffer at the first time when an RRC Inactive state is kept from the action of receiving a first signaling till the first time.

In one embodiment, the action of not flushing the first buffer comprises dropping flushing the first buffer.

In one embodiment, the action of not flushing the first buffer comprises not performing any relevant action of flushing the first buffer.

In one embodiment, the action of not flushing the first buffer comprises the first buffer not being refreshed.

In one embodiment, the phrase of “flushing the first buffer at the first time when an RRC Connected state is kept from the action of receiving the first signaling till the first time” comprises: flushing the first buffer at the first time if an RRC Connected state is kept from the action of receiving the first signaling till the first time.

In one embodiment, the phrase of “not flushing the first buffer at the first time when an RRC Inactive state is kept from the action of receiving the first signaling till the first time” comprises: not flushing the first buffer at the first time if an RRC Inactive state is kept from the action of receiving the first signaling till the first time.

In one embodiment, as a response to the action of receiving a first signaling, drop starting the first timer; the action of dropping starting the first timer is used to determine that expiration does not occur in the first timer at the first time, and the fact that the expiration does not occur in the first timer at the first time is used to determine that the first buffer is not flushed at the first time.

In one embodiment, as a response to the action of receiving the first signaling, apply the first Timing Advance, and initiate the first timer; herein, the time while the first timer is running from the action of receiving the first signaling till the first time reaches the first expiration value of the first timer.

In one embodiment, the first buffer is flushed at the first time when transiting from an RRC Inactive state to an RRC Connected state from the action of receiving the first signaling till the first time.

In one embodiment, the first buffer is not flushed at the first time when transiting from an RRC Inactive state to an RRC Connected state from the action of receiving the first signaling till the first time.

In one embodiment, the first buffer is flushed at the first time when transiting from an RRC Connected state to an RRC Inactive state from the action of receiving the first signaling till the first time.

In one embodiment, receive a first message; and, as a response to the action of receiving the first message, transit the first node from an RRC Inactive state to an RRC Connected state; where the first message is received between the action of receiving a first signaling and the first time.

In one embodiment, receive a first message; and, as a response to the action of receiving the first message, transit the first node from an RRC Inactive state to an RRC Connected state; where the first message is received at a time after the first time.

In one embodiment, receive a RRCRelease message; and, as a response to the action of receiving the RRCRelease message, transit the first node from an RRC Connected state to an RRC Inactive state; where the RRCRelease message is received between the action of receiving a first signaling and the first time.

In one embodiment, receive a RRCRelease message; and, as a response to the action of receiving the RRCRelease message, transit the first node from an RRC Connected state to an RRC Inactive state; where the RRCRelease message is received at a time after the first time.

In one embodiment, receive a RRCRelease message; and, as a response to the action of receiving the RRCRelease message, keep the first node in an RRC Inactive state; where the RRCRelease message is received between the action of receiving a first signaling and the first time; an RRC Inactive state is kept from the action of receiving the first signaling till the first time.

In one embodiment, determine according to at least an RRC state whether RRC is notified of releasing a Physical Uplink Control Channel (PUCCH) at a first time, where the PUCCH is configured, and belongs to any serving cell.

In one embodiment, determine according to at least an RRC state whether RRC is notified of releasing a Sounding Reference Signal (SRS) at a first time, where the SRS is configured, and belongs to any serving cell.

In one embodiment, determine according to at least an RRC state whether Configured Downlink Assignments and Configured Uplink Grants are cleared at a first time.

In one embodiment, determine according to at least an RRC state whether PUSCH resources of Semi-Persistent Channel State Information (CSI) reporting are cleared at a first time.

In one embodiment, determine according to at least an RRC state whether all running first-type timers are assumed to be expired at a first time.

In one embodiment, determine according to at least an RRC state whether N_{TA} of each Timing Advance Group (TAG) is maintained at a first time.

In one embodiment, determine according to at least an RRC state whether a first buffer is flushed, or whether RRC is notified of releasing a PUCCH, or whether RRC is notified of releasing an SRS, or whether Configured Downlink Assignments and Configured Uplink Grants are cleared, or whether PUSCH resources of Semi-Persistent CSI reporting are cleared, or whether N_{TA} of each TAG is maintained, at a first time.

In one subembodiment, when an RRC Connected state is kept between the action of applying the first Timing Advance and the first time, perform at least one of the following, at a first time: flushing a first buffer, or notifying RRC of releasing a PUCCH, or notifying RRC of releasing an SRS, or clearing Configured Downlink Assignments and Configured Uplink Grants, or clearing PUSCH resources of Semi-Persistent CSI reporting, or assuming that all running first-type timers are expired, or maintaining N_{TA} of each TAG.

In one subembodiment, when an RRC Inactive state is kept between the action of applying the first Timing

Advance and the first time, do not perform at least one of the following, at a first time: flushing a first buffer, or notifying RRC of releasing a PUCCH, or notifying RRC of releasing an SRS, or clearing Configured Downlink Assignments and Configured Uplink Grants, or clearing PUSCH resources of Semi-Persistent CSI, or assuming that all running first-type timers are expired, or maintaining N_TA of each TAG.

In one embodiment, the action of determining whether an action is performed at a first time according to at least an RRC state comprises:

performing the action at the first time when an RRC Connected state is kept from the action of receiving the first signaling till the first time; or

not performing the action at the first time when an RRC Inactive state is kept from the action of receiving the first signaling till the first time.

In one embodiment, the action of determining whether an action is performed at a first time according to at least an RRC state comprises:

performing the action at the first time when an RRC Connected state is kept from the action of receiving the first signaling till the first time, and the first parameter set is satisfied; or

not performing the action at the first time when an RRC Inactive state is kept from the action of receiving the first signaling till the first time, and the first parameter set is satisfied.

In one embodiment, the action of performing an action comprises at least one of: flushing a first buffer, or notifying RRC of releasing a PUCCH, or notifying RRC of releasing an SRS, or clearing Configured Downlink Assignments and Configured Uplink Grants, or clearing PUSCH resources of Semi-Persistent CSI reporting, or assuming that all running first-type timers are expired, or maintaining N_{TA} of each TAG.

In one embodiment, the phrase that a time interval from the action of receiving the first signaling till the first time is larger than or equal to a first expiration value of a first timer comprises: starting from the action of receiving the first signaling, a time determined by going through a time interval equal to the first expiration value of the first timer is the first time.

In one embodiment, the phrase that a time interval from the action of receiving the first signaling till the first time is larger than or equal to a first expiration value of a first timer comprises: starting from the action of receiving the first signaling, a time determined by going through a time interval larger than the first expiration value of the first timer is the first time.

In one embodiment, the phrase that a time interval from the action of receiving the first signaling till the first time is larger than or equal to a first expiration value of a first timer comprises: a time interval between the action of receiving the first signaling and the first time is larger than the first expiration value of the first timer.

In one embodiment, the phrase that a time interval from the action of receiving the first signaling till the first time is larger than or equal to a first expiration value of a first timer comprises: a time interval between the action of receiving the first signaling and the first time is equal to the first expiration value of the first timer.

In one embodiment, the first timer is a first-type timer.

In one subembodiment, any timer among the first-type timers includes a timeAlignmentTimer.

In one subembodiment, a timer among the first-type timers includes the first timer.

In one subembodiment, any timer among the first-type timers is associated with a TAG.

In one subembodiment, a timer among the first-type timers is used for determining how long a MAC entity considers uplink time of a serving cell that belongs to a TAG associated with the timer is aligned.

In one subembodiment, during the time while a timer among the first-type timers is running, a MAC entity considers that uplink time of a serving cell that belongs to a TAG is aligned, the timer being associated with the TAG.

In one subembodiment, any timer among the first-type timers is used for maintaining uplink time alignment.

In one embodiment, the first expiration value refers to an expiration value of the first timer.

In one embodiment, the first expiration value is an expiration value of the first timer configured by an RRC message.

In one embodiment, the first expiration value is configured by at least one of a SIB1 message, or a RRCReconfiguration message, or a RRCResume message, or a RRCSetup mesage.

In one embodiment, the first expiration value is configured by at least one of an IE TAG-Config, or an IE UplinkConfigCommon, or an IE UplinkConfigCommonSIB, or an IE ServingCellConfigCommonSIB, or an IE ServingCellConfigCommon, or an IE CellGroupConfig.

In one embodiment, the first expiration value is configured by a field in an RRC message, where the field's name includes TimeAlignmentTimer.

In one embodiment, the first expiration value comprises a positive integer number of slot(s), where the slot comprises at least one of slot(s), or subframe(s), or Radio Frame(s), or multiple Orthogonal Frequency Division Multiplexing (OFDM) symbols, or multiple Single Carrier Frequency Division Multiple Access (SC-FDMA) symbols.

In one embodiment, a said message indicating the Timing Advance comprises a physical layer message.

In one embodiment, a said message indicating the Timing Advance comprises a MAC layer message.

In one embodiment, a said message indicating the Timing Advance comprises a RRC layer message.

In one embodiment, a said message indicating the Timing Advance comprises a MAC RAR.

In one embodiment, a said message indicating the Timing Advance comprises a fallbackRAR.

In one embodiment, a said message indicating the Timing Advance comprises a successRAR.

In one embodiment, a said message indicating the Timing Advance comprises a Timing Advance Command MAC CE.

In one embodiment, a said message indicating the Timing Advance comprises an Absolute Timing Advance Command MAC CE.

In one embodiment, a said message indicating the Timing Advance comprises a Timing Delta MAC CE.

In one embodiment, a said message indicating the Timing Advance refers to a message carrying a Timing Advance Command field.

In one embodiment, the phrase that not any message that indicates a Timing Advance is received from the action of receiving the first signaling till the first time comprises that there isn't any message that carries Timing Advance Command field being received from the action of receiving the first signaling till the first time.

In one embodiment, the phrase that not any message that indicates a Timing Advance is received from the action of receiving the first signaling till the first time comprises that there isn't any one of a MAC RAR, or a fallbackRAR, or a successRAR, or a Timing Advance Command MAC CE, or an Absolute Timing Advance Command MAC CE or a Timing Delta MAC CE being received from the action of receiving the first signaling till the first time.

In one embodiment, the phrase that not any message that indicates a Timing Advance is received from the action of receiving the first signaling till the first time comprises that there isn't any message that comprises an index value T_A being received from the action of receiving the first signaling till the first time.

In one embodiment, the phrase that not any message that indicates a Timing Advance is received from the action of receiving the first signaling till the first time comprises that there isn't any message that is used for calculating N_TA being received from the action of receiving the first signaling till the first time.

In one embodiment, as a response to the action of receiving a first signaling, initiate the first timer; from the action of receiving the first signaling till the first time the first timer is not re-started.

In one embodiment, as a response to the action of receiving a first signaling, drop starting the first timer; from the action of receiving the first signaling till the first time the first timer is neither started nor re-started.

In one embodiment, as a response to the action of receiving a first signaling, initiate the first timer; from the action of receiving the first signaling till the first time the first timer is re-started; the action of the first timer being re-started from the action of receiving the first signaling till the first time is triggered by factors other than the first signaling.

In one embodiment, as a response to the action of receiving a first signaling, drop starting the first timer; from the action of receiving the first signaling till the first time the first timer is started or re-started; the action of the first timer being started or re-started from the action of receiving the first signaling till the first time is triggered by factors other than the first signaling.

In one embodiment, starting a timer comprises: a value of the timer begins to update with time, the timer including the first timer or the second timer.

In one embodiment, starting a timer comprises: a value of the timer starts to count time, the timer including the first timer or the second timer.

In one embodiment, starting a timer comprises: a value of the timer starts to count time from 0, the timer including the first timer or the second timer.

In one embodiment, starting a timer comprises: the timer proceeds to count time from a value suspended from last time, the timer including the first timer or the second timer.

In one embodiment, starting a timer comprises: stop and then initiate the timer, the timer including the first timer or the second timer.

In one embodiment, starting a timer comprises: when the timer is running, set a value of the timer to 0 and start to count time from 0, the timer including the first timer or the second timer.

In one embodiment, starting a timer comprises: when the timer is not running, the timer starts to count time from 0, the timer including the first timer or the second timer.

In one embodiment, starting a timer comprises: when the timer is not running, the timer proceeds to count time from a value suspended from last time, the timer including the first timer or the second timer.

In one embodiment, the meaning of starting includes: to start.

In one embodiment, the meaning of starting includes: to restart.

In one embodiment, the meaning of starting includes: starting.

In one embodiment, the meaning of starting includes: restarting.

In one embodiment, the meaning of starting includes: re-starting.

In one embodiment, the meaning of starting includes: resetting.

In one embodiment stopping a timer includes: the timer does not continue time counting.

In one embodiment stopping a timer includes: the timer does not continue running

In one embodiment, a timer being running comprises: after being started the timer is not stopped, nor is the timer expired, the timer including the first timer or the second timer.

In one embodiment, a timer being running comprises: a value of the timer is not 0, the timer including the first timer or the second timer.

In one embodiment, a timer being running comprises: a value of the timer is greater than 0 and no greater than an expiration value of the timer, the timer including the first timer or the second timer.

In one embodiment, a timer being running comprises: a value of the timer is greater than 0 and less than an expiration value of the timer, the timer including the first timer or the second timer.

In one embodiment, a timer being running comprises: a value of the timer is changing, the timer including the first timer or the second timer.

In one embodiment, a timer being running comprises: the timer never stops time counting, the timer including the first timer or the second timer.

In one embodiment, a timer being running comprises: the timer is not expired, the timer including the first timer or the second timer.

In one embodiment, a timer being running comprises: the time while the timer is continuously running reaches an expiration value of the timer, the timer including the first timer or the second timer.

In one embodiment, a timer being running comprises: the time while the timer is running reaches an expiration value of the timer, the timer including the first timer or the second timer.

In one embodiment, when the time while a timer is running reaches an expiration value of the timer, the timer is expired, the timer including the first timer or the second timer.

In one embodiment, when a value of a timer is equal to an expiration value of the timer, the timer is expired, the timer including the first timer or the second timer.

In one embodiment, when a value of a timer is greater than an expiration value of the timer, the timer is expired, the timer including the first timer or the second timer.

In one embodiment, the expiration value refers to a maximum running time.

In one embodiment, the expiration value is configured by an RRC message.

In one embodiment, the expiration value is configured by an IE in an RRC message.

In one embodiment, the expiration value is configured by a field in an RRC message.

In one embodiment, the expiration value comprises a positive integer number of slot(s).

In one embodiment, the running time refers to the time of continuous running

In one embodiment, the running time refers to the time of non-continuous running

### Embodiment 2

Embodiment 2 illustrates a schematic diagram of a network architecture according to one embodiment of the present application, as shown in FIG. 2. FIG. 2 is a diagram illustrating a network architecture 200 of 5G NR, Long-Term Evolution (LTE) and Long-Term Evolution Advanced (LTE-A) systems. The 5G NR or LTE network architecture 200 may be called a 5G System/Evolved Packet System (5GS/EPS) 200 or other suitable terminology. The 5GS/EPS 200 may comprise one or more UEs 201, an NG-RAN 202, a 5G-Core Network/Evolved Packet Core (5GC/EPC) 210, a Home Subscriber Server/Unified Data Management(HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 is a UE.

In one embodiment, the gNB203 corresponds to the second node in the present application.

In one embodiment, the gNB203 is a Base Station (BS).

In one embodiment, the gNB203 is a UE.

In one embodiment, the gNB203 is a relay.

In one embodiment, the gNB203 is a Gateway.

In one embodiment, the UE supports transmissions in Non-Terrestrial Network (NTN).

In one embodiment, the UE supports transmissions in Terrestrial Network (TN).

In one embodiment, the UE supports transmissions in large-delay-difference networks.

In one embodiment, the UE supports Dual Connection (DC) transmissions.

In one embodiment, the UE comprises an aircraft.

In one embodiment, the UE comprises a vehicle-mounted terminal.

In one embodiment, the UE comprises a vessel.

In one embodiment, the UE comprises an Internet-of-Things (IoT) terminal.

In one embodiment, the UE comprises an Industrial IoT (IIoT) terminal.

In one embodiment, the UE is a piece of equipment supporting transmissions with low delay and high reliability.

In one embodiment, the UE comprises test equipment.

In one embodiment, the UE comprises a signaling test instrument.

In one embodiment, the UE comprises equipment of Narrow Band Internet of Things (NB-IOT).

In one embodiment, the UE comprises an Integrated Access and Backhaul-node (IAB-node).

In one embodiment, the UE comprises an IAB-DU.

In one embodiment, the UE comprises an IAB-MT.

In one embodiment, the base station supports transmissions in NTN.

In one embodiment, the base station supports transmissions in large-delay-difference networks.

In one embodiment, the base station supports transmissions in TN.

In one embodiment, the base station comprises a MacroCellular base station.

In one embodiment, the base station comprises a Micro Cell base station.

In one embodiment, the base station comprises a Pico Cell base station.

In one embodiment, the base station comprises a Femtocell.

In one embodiment, the base station comprises a base station device supporting large time-delay difference.

In one embodiment, the base station comprises a flight platform.

In one embodiment, the base station comprises satellite equipment.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises test equipment.

In one embodiment, the base station comprises a signaling test instrument.

In one embodiment, the base station comprises an IAB-node.

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a relay.

In one embodiment, the relay comprises a L3 relay.

In one embodiment, the relay comprises a L2 relay.

In one embodiment, the relay comprises a Router.

In one embodiment, the relay comprises an Exchanger.

In one embodiment, the relay comprises a UE.

In one embodiment, the relay comprises a base station.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 is represented by three layers, namely, layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between the UE and the gNB via the PHY 301. The L2 305 comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a packet and provides support for inter-cell handover. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics.

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC 306.

In one embodiment, the first signaling in the present application is generated by the MAC302 or the MAC352.

In one embodiment, the first signaling in the present application is generated by the PHY301 or the PHY351.

In one embodiment, the first message in the present application is generated by the RRC306.

In one embodiment, the first message in the present application is generated by the MAC302 or the MAC352.

In one embodiment, the first message in the present application is generated by the PHY301 or the PHY351.

In one embodiment, the second message set in the present application is generated by the RRC306.

In one embodiment, the second message set in the present application is generated by the PDCP304 or the PDCP354.

In one embodiment, the second message set in the present application is generated by the RLC303 or the RLC353.

In one embodiment, the second message set in the present application is generated by the MAC302 or the MAC352.

In one embodiment, the second message set in the present application is generated by the PHY301 or the PHY351.

### Embodiment 4

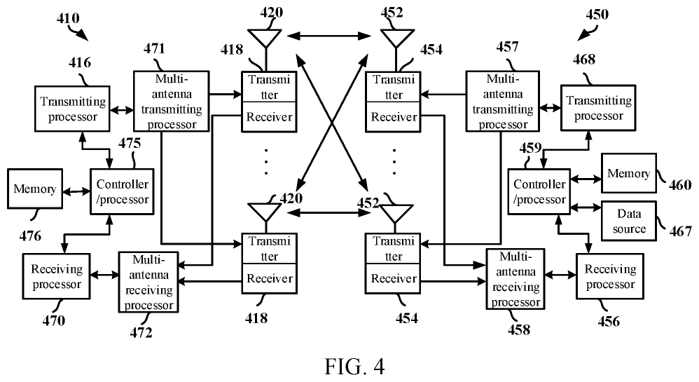

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also responsible for a retransmission of a lost packet, and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping of signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transit (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also in charge of a retransmission of a lost packet and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450.

Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with a memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least receives a first signaling, the first signaling being used to determine a first Timing Advance; and determines according to at least an RRC state whether a first buffer is flushed at a first time; herein, a time interval from the action of receiving the first signaling till the first time is larger than or equal to a first expiration value of a first timer; not any message that indicates a Timing Advance is received from the action of receiving the first signaling till the first time; the action of determining according to at least an RRC state whether a first buffer is flushed at a first time comprises: flushing the first buffer at the first time when an RRC Connected state is kept from the action of receiving the first signaling till the first time; or not flushing the first buffer at the first time when an RRC Inactive state is kept from the action of receiving the first signaling till the first time.

In one embodiment, the first communication device 450 comprises a memory that stores a computer readable instruction program. The computer readable instruction program generates an action when executed by at least one processor. The action includes: receiving a first signaling, the first signaling being used to determine a first Timing Advance; and determining according to at least an RRC state whether a first buffer is flushed at a first time;

herein, a time interval from the action of receiving the first signaling till the first time is larger than or equal to a first expiration value of a first timer; not any message that indicates a Timing Advance is received from the action of receiving the first signaling till the first time; the action of determining according to at least an RRC state whether a first buffer is flushed at a first time comprises: flushing the first buffer at the first time when an RRC Connected state is kept from the action of receiving the first signaling till the first time; or not flushing the first buffer at the first time when an RRC Inactive state is kept from the action of receiving the first signaling till the first time.

In one embodiment, the second communication device 410 comprises at least one processor and at least one memory. The at least one memory comprises computer program codes; the at least one memory and the computer program codes are configured to be used in collaboration with the at least one processor. The second communication device 410 at least transmits a first signaling, the first signaling being used to determine a first Timing Advance; herein, whether a first buffer is flushed at a first time is determined according to at least an RRC state; a time interval from the first signaling being received till the first time is larger than or equal to a first expiration value of a first timer; not any message that indicates a Timing Advance is received from the first signaling being received till the first time; the phrase that whether a first buffer is flushed at a first time is determined according to at least an RRC state comprises: the first buffer being flushed at the first time when an RRC Connected state is kept from the first signaling being received till the first time; or the first buffer not being flushed at the first time when an RRC Inactive state is kept from the first signaling being received till the first time.

In one embodiment, the second communication device 410 comprises a memory that stores a computer readable instruction program. The computer readable instruction program generates an action when executed by at least one processor. The action includes: transmitting a first signaling, the first signaling being used to determine a first Timing Advance; herein, whether a first buffer is flushed at a first time is determined according to at least an RRC state; a time interval from the first signaling being received till the first time is larger than or equal to a first expiration value of a first timer; not any message that indicates a Timing Advance is received from the first signaling being received till the first time; the phrase that whether a first buffer is flushed at a first time is determined according to at least an RRC state comprises: the first buffer being flushed at the first time when an RRC Connected state is kept from the first signaling being received till the first time; or the first buffer not being flushed at the first time when an RRC Inactive state is kept from the first signaling being received till the first time.

In one embodiment, the antenna 452, the receiver 454, the receiving processor 456, and the controller/processor 459 are used to receive a first signaling; at least one of the antenna 420, the transmitter 418, the transmitting processor 416, or the controller/processor 475 is used to transmit a first signaling

In one embodiment, the antenna 452, the receiver 454, the receiving processor 456, and the controller/processor 459 are used to receive a first message; at least one of the antenna 420, the transmitter 418, the transmitting processor 416, or the controller/processor 475 is used to transmit a first message.

In one embodiment, the antenna 452, the transmitter 454, the transmitting processor 468, and the controller/processor 459 are used to transmit a second message set; at least one of the antenna 420, the receiver 418, the receiving processor 470, or the controller/processor 475 is used to receive a second message set.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a UE supporting large delay difference.

In one embodiment, the first communication device 450 is a UE supporting NTN.

In one embodiment, the first communication device 450 is an aircraft.

In one embodiment, the first communication device 450 is capable of positioning.

In one embodiment, the first communication device 450 is incapable of positioning.

In one embodiment, the first communication device 450 is a UE supporting TN.

In one embodiment, the second communication device 410 is a base station (gNB/eNB/ng-eNB).

In one embodiment, the second communication device 410 is a base station supporting large delay difference.

In one embodiment, the second communication device 410 is a base station supporting NTN.

In one embodiment, the second communication device 410 is satellite equipment.

In one embodiment, the second communication device 410 is a flight platform.

In one embodiment, the second communication device 410 is a base station supporting TN.

### Embodiment 5

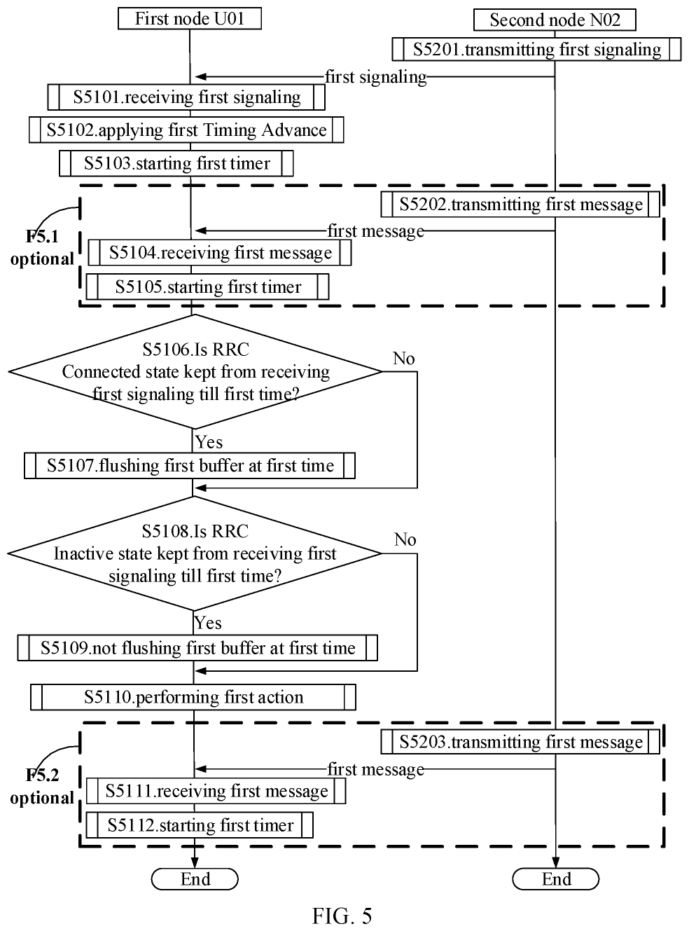

Embodiment 5 illustrates a flowchart of radio signal transmission according to one embodiment of the present application, as shown in FIG. 5. It should be particularly noted that the sequence illustrated herein does not set any limit to the signal transmission order or implementation order in the present application.

The first node U01 receives a first signaling in step S5101; as a response to the action of receiving a first signaling, applies a first TA in step S5102; as a response to the action of receiving a first signaling, initiates a first timer in step S5103; and receives a first message in step S5104; as a response to the action of receiving a first message, initiates a first timer in step S5105; determines according to at least an RRC state whether a first buffer is flushed at a first timer in step S5106; when an RRC Connected state is kept from the action of receiving a first signaling till the first time, enter step S5107; otherwise, enter step S5108; in step S5107, flushes the first buffer at the first time; in step S5108, when an RRC Inactive state is kept from the action of receiving the first signaling till the first time, enter step S5109, otherwise, enter step S5110; in step S5109, does not flush the first buffer at the first time; in step S5110, performs a first action; in step S5111, receives a first message; and in step S5112, initiates the first timer as a response to the action of receiving the first message.

The second node N02 transmits the first signaling in step S5201; transmits the first message in step S5202; and transmits the first message in step S5203.

In Embodiment 5, the first signaling is used to determine a first Timing Advance; a time interval from the action of receiving the first signaling till the first time is larger than or equal to a first expiration value of a first timer; not any message that indicates a Timing Advance is received from the action of receiving the first signaling till the first time; the time while the first timer is running from the action of receiving the first signaling till the first time reaches the first expiration value of the first timer; the first message is used for transition of the RRC state.

In one embodiment, the action of determining according to at least an RRC state whether a first buffer is flushed at a first time comprises: flushing the first buffer at the first time when an RRC Connected state is kept from the action of receiving the first signaling till the first time; or not flushing the first buffer at the first time when an RRC Inactive state is kept from the action of receiving the first signaling till the first time.

In one embodiment, the time while the first timer is running from the action of receiving the first signaling till the first time reaches the first expiration value of the first timer.

In one embodiment, as a response to the action of receiving a first signaling, drop starting the first timer.

In one embodiment, the phrase that as a response to the action of receiving a first signaling comprises: when receiving the first signaling.

In one embodiment, the phrase that as a response to the action of receiving a first signaling comprises: as soon as the first signaling is received.

In one embodiment, the phrase that as a response to the action of receiving a first signaling comprises: after receiving the first signaling.

In one embodiment, the phrase that “as a response to the action of receiving the first signaling, apply the first TA and initiate the first timer” comprises: the action of receiving the first signaling triggers the action of applying the first TA and the action of starting the first timer.

In one embodiment, the phrase that “as a response to the action of receiving the first signaling, apply the first TA and initiate the first timer” comprises: the action of applying the first TA and the action of starting the first timer are actions performed concurrently with or after the action of receiving a first signaling.

In one embodiment, the action of applying the first TA comprises: adjusting an uplink timing according to the first TA.

In one embodiment, the action of applying the first TA comprises: adjusting an uplink transmission timing according to the first TA.

In one embodiment, the action of applying the first TA comprises: adjusting an uplink transmission time according to the first TA.

In one embodiment, the action of applying the first TA comprises: acquiring the N_{TA new} in TS 38.213, section 4.2 according to the first TA.

In one embodiment, the action of applying the first TA comprises: acquiring the N_{TA} in TS 38.213, section 4.2 according to the first TA.

In one embodiment, the phrase that the time while the first timer is running from the action of receiving the first signaling till the first time reaches the first expiration value of the first timer comprises that at the first time, the first timer expires.

In one embodiment, the phrase that the time while the first timer is running from the action of receiving the first signaling till the first time reaches the first expiration value of the first timer comprises that before the first time, the first timer expires.

In one embodiment, the phrase that the time while the first timer is running from the action of receiving the first signaling till the first time reaches the first expiration value of the first timer comprises that the first timer is started from the action of receiving a first signaling till the first time, and the first timer is expired between the action of receiving the first signaling and the first time.

In one embodiment, the statement that “a time interval from the action of receiving the first signaling till the first time is larger than or equal to a first expiration value of a first timer; not any message that indicates a Timing Advance is received from the action of receiving the first signaling till the first time; the time while the first timer is running from the action of receiving the first signaling till the first time reaches the first expiration value of the first timer” comprises: starting from the action of receiving the first signaling till the first time, the first timer, once started, keeps running till the first timer expires.

In one embodiment, the first time comprises an instant of time when the first timer is expired.

In one embodiment, the first time comprises an instant of time of dropping flushing the first buffer when the first timer is expired.

In one embodiment, the first time comprises an instant of time of dropping flushing the first buffer when the first timer is expired.

In one embodiment, the first message is transmitted via an air interface.

In one embodiment, the first message is transmitted via an antenna port.

In one embodiment, the first message is transmitted via an upper layer signaling.

In one embodiment, the first message is transmitted via a higher layer signaling.

In one embodiment, the first message comprises a Downlink (DL) signal.

In one embodiment, the first message comprises a Sidelink (SL) signal.

In one embodiment, the first message comprises all or part of an upper layer signaling.

In one embodiment, the first message comprises all or part of a higher layer signaling.

In one embodiment, the first message comprises a Message 4 (Msg4).

In one embodiment, the first message comprises part of a Message B (MsgB).

In one embodiment, the first message comprises an RRC message.

In one embodiment, the first message comprises all or part of IEs in an RRC message.

In one embodiment, the first message comprises all or part of fields of an IE in an RRC message.

In one embodiment, a Signaling Radio Bearer (SRB) for the first message includes SRB1.

In one embodiment, the first message comprises a Common Control CHannel (CCCH) message.

In one embodiment, the first message comprises a RRCResume message.

In one embodiment, the first message comprises a RRCSetup message.

In one embodiment, the first message comprises a RRCReject message.

In one embodiment, the first message comprises a RRCRelease message.

In one embodiment, the first message comprises no RRCRelease message.

In one embodiment, the first message comprises a RRCEarlyDataComplete message.

In one embodiment, the first message comprises no RRCEarlyDataComplete message.

In one embodiment, names of the second message set include at least one of RRC or Connection or Resume, or Release, or RRCReject or Setup, or Reconfiguration, or Complete, or sdt, idt or Inactive, or Small, or Data or Transmission.

In one embodiment, names of the second message set include at least one of RRC or Resume, or sdt or idt, or Inactive or Small, Data, Transmission or Request.

In one embodiment, the phrase that “as a response to the action of receiving a first message, starting the first timer” comprises: the action of starting the first timer is triggered by the action of receiving a first message.

In one embodiment, the phrase that “as a response to the action of receiving a first message, starting the first timer” comprises: upon reception of the first message, starting the first timer is triggered.

In one embodiment, the phrase that “as a response to the action of receiving a first message, starting the first timer” comprises: the action of starting the first timer is an action triggered by the action of receiving a first message.

In one embodiment, the phrase that “as a response to the action of receiving a first message, starting the first timer” comprises: as a response to the action of receiving a first message, an RRC layer of the first node sends a notification to a MAC layer of the first node, when the MAC layer of the first node receives the notification, the first timer is started.

In one embodiment, the phrase that “as a response to the action of receiving a first message, starting the first timer” comprises: as a response to the action of receiving a first message, an RRC layer of the first node indicates to a MAC layer of the first node that the first timer is started.

In one embodiment, the phrase that the first message is used for transiting the RRC state comprises: the first message is used to transit the first node from the RRC Connected state to the RRC Inactive state.

In one embodiment, the phrase that the first message is used for transiting the RRC state comprises: the first message is used to transit the first node from the RRC Inactive state to the RRC Connected state.

In one embodiment, the phrase that the first message is used for transiting the RRC state comprises: the first message is used to transit an RRC state to another RRC state.

In one embodiment, the phrase that the first message is used for transiting the RRC state comprises: receiving the first message triggers the transition of the RRC state.

In one embodiment, the action of performing a first action comprises flushing the first buffer at the first time.

In one embodiment, the action of performing a first action comprises not flushing the first buffer at the first time.

In one embodiment, as a response to the action of receiving a first message, initiate the first timer; the expiration value of the first timer is the first expiration value.

In one embodiment, as a response to the action of receiving a first message, initiate the first timer; the expiration value of the first timer is the second expiration value.

In one embodiment, the dotted-line box F5.1 is optional.

In one embodiment, the dotted-line box F5.1 exists.

In one embodiment, the dotted-line box F5.1 doesn't exist.

In one embodiment, the dotted-line box F5.2 is optional.

In one embodiment, the dotted-line box F5.2 exists.

In one embodiment, the dotted-line box F5.2 doesn't exist.

### Embodiment 6

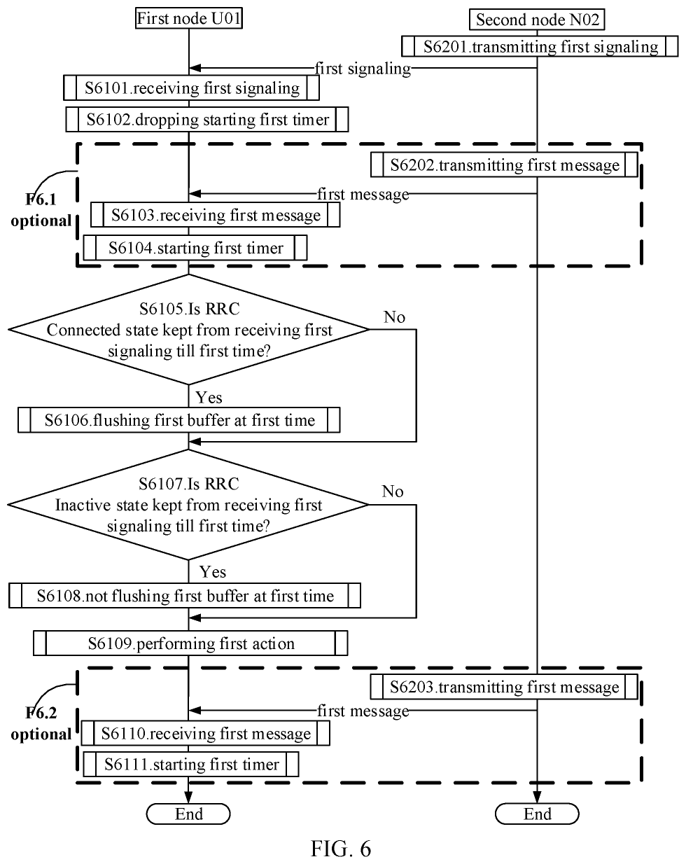

Embodiment 6 illustrates a flowchart of signal transmission according to another embodiment of the present application, as shown in FIG. 6. It should be particularly noted that the sequence illustrated herein does not set any limit to the signal transmission order or implementation order in the present application.

The first node U01 receives a first signaling in step S6101; as a response to the action of receiving a first signaling, drops starting a first timer in step S6102; and receives a first message in step S6103; as a response to the action of receiving a first message, initiates a first timer in step S6104; determines according to at least an RRC state whether a first buffer is flushed at a first timer in step S6105; when an RRC Connected state is kept from the action of receiving a first signaling till the first time, enter step S6106; otherwise, enter step S6107; in step S6106, flushes the first buffer at the first time; in step S6107, when an RRC Inactive state is kept from the action of receiving the first signaling till the first time, enter step S6108, otherwise, enter step S6109; in step S6108, does not flush the first buffer at the first time; in step S6109, performs a first action; in step S6110, receives a first message; and in step S6111, initiates the first timer as a response to the action of receiving the first message.

The second node NO2 transmits the first signaling in step S6201; transmits the first message in step S6202; and transmits the first message in step S6203.

In Embodiment 6, the first signaling is used to determine a first Timing Advance; a time interval from the action of receiving the first signaling till the first time is larger than or equal to a first expiration value of a first timer; not any message that indicates a Timing Advance is received from the action of receiving the first signaling till the first time; the first message is used for transition of the RRC state.

In one embodiment, as a response to the action of receiving a first signaling, drop starting the first timer.

In one embodiment, as a response to the action of receiving the first signaling, drop applying the first Timing Advance, and drop starting the first timer.

In one embodiment, as a response to the action of receiving the first signaling, apply the first Timing Advance, and drop starting the first timer.

In one embodiment, the action of dropping starting the first timer is used to determine that the first timer is not expired at the first time, and the first timer not being expired at the first time is used to determine that the first buffer is not flushed at the first time.

In one embodiment, as a response to the action of receiving the first signaling, apply the first Timing Advance.

In one embodiment, as a response to the action of receiving the first signaling, drop applying the first Timing Advance.

In one embodiment, as a response to the action of receiving the first signaling, drop applying the first Timing Advance, and drop starting the first timer.

In one embodiment, the action of dropping applying the first Timing Advance comprises: not applying the first Timing Advance.

In one embodiment, the action of dropping applying the first Timing Advance comprises: ignoring the first Timing Advance.

In one embodiment, the action of dropping applying the first Timing Advance comprises: ignoring a received Timing Advance Command.

In one embodiment, the action of dropping starting the first timer comprises: not starting the first timer.

In one embodiment, the action of dropping starting the first timer comprises: the first timer does not start time counting.

In one embodiment, the action of dropping starting the first timer comprises: the state of the first timer stays unchanged.

In one embodiment, the dotted-line box F6.1 is optional.

In one embodiment, the dotted-line box F6.1 exists.

In one embodiment, the dotted-line box F6.1 doesn't exist.

In one embodiment, the dotted-line box F6.2 is optional.

In one embodiment, the dotted-line box F6.2 exists.

In one embodiment, the dotted-line box F6.2 doesn't exist.

### Embodiment 7

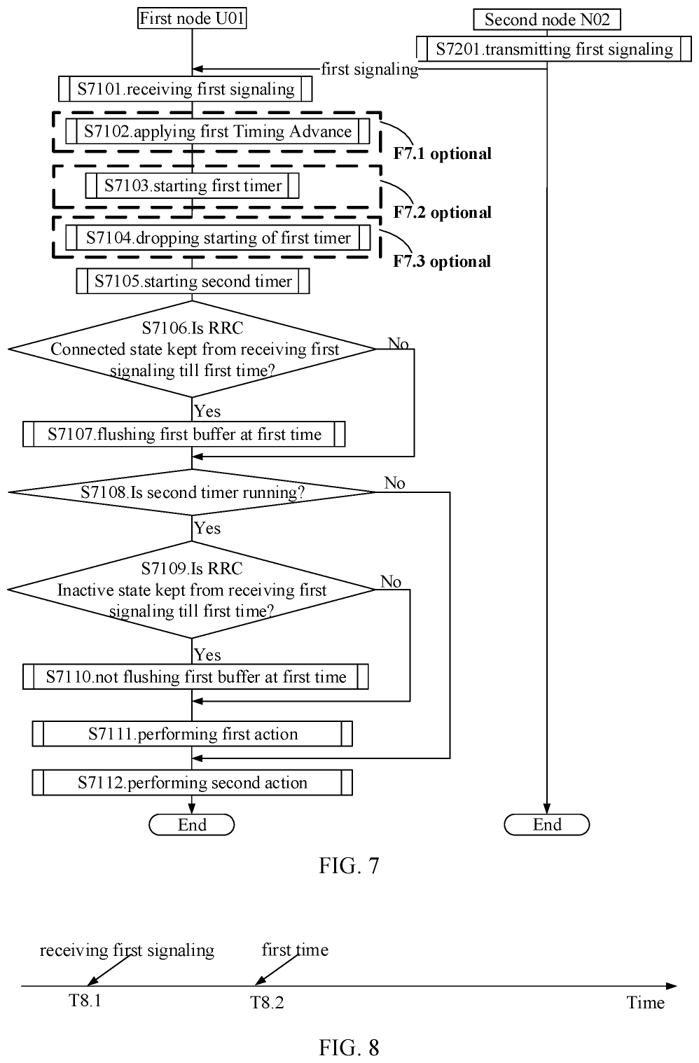

Embodiment 7 illustrates a flowchart of signal transmission according to another embodiment of the present application, as shown in FIG. 7. It should be particularly noted that the sequence illustrated herein does not set any limit to the signal transmission order or implementation order in the present application.

The first node U01 receives a first signaling in step S7101; as a response to the action of receiving a first signaling, applies a first TA in step S7102; as a response to the action of receiving a first signaling, initiates a first timer in step S7103; and, as a response to the action of receiving the first signaling, drops starting a first timer in step S7104; in step S7105, as a response to the action of receiving the first signaling, initiates a second timer; and determines according to at least an RRC state whether a first buffer is flushed at a first timer in step S7106; when an RRC Connected state is kept from the action of receiving a first signaling till the first time, enter step S7107; otherwise, enter step S7108; in step S7107, flushes the first buffer at the first time; in step S7108, determines whether the first buffer is flushed at the first time according at least to whether the second timer is running; when the second timer is running, enter step S7109, otherwise, enter step S7112; in step S7109, when an RRC Inactive state is kept from the action of receiving the first signaling till the first time, enter step S7110, otherwise, enter step S7111; in step S7110, does not flush the first buffer at the first time; in step S7111, performs a first action; in step S7112, performs a second action.

The second node N02 transmits the first signaling in step S7201.

In Embodiment 7, the first signaling is used to determine a first Timing Advance; a time interval from the action of receiving the first signaling till the first time is larger than or equal to a first expiration value of a first timer; not any message that indicates a Timing Advance is received from the action of receiving the first signaling till the first time; the first message is used for transition of the RRC state; the second timer is different from the first timer.

In one embodiment, as a response to the action of receiving the first signaling, apply the first Timing Advance, and initiate the first timer; herein, the time while the first timer is running from the action of receiving the first signaling till the first time reaches the first expiration value of the first timer.

In one embodiment, as a response to the action of receiving a first signaling, initiate or re-initiate the second timer.

In one embodiment, when a RRCRelease message is received, and the RRCRelease message carries the configuration of the preconfigured resources, and the second timer is configured, an RRC layer sends an indication to a MAC layer, and the MAC layer initiates the second timer according to the indication of the RRC layer.

In one embodiment, when a RRCConnectionRelease message is received, and the RRCConnectionRelease message carries the configuration of the preconfigured resources, and the second timer is configured, an RRC layer of the first node sends an indication to a MAC layer of the first node, and the MAC layer of the first node initiates the second timer according to the indication of the RRC layer of the first node.

In one embodiment, an RRC layer of the first node verifies that a TA associated with the preconfigured resources is valid, and sends a validity indication to a MAC layer of the first node, when the MAC layer of the first node receives the validity indication, it initiates or re-initiates the second timer.

In one subembodiment, whether the TA associated with the preconfigured resources is valid is related to at least one of a change of a Reference Signal Received Power (RSRP), or a Synchronization Signal (SS)/Physical broadcast channel (PBCH) Block, or a mapping relation between an SS/PBCH block (SSB) and the preconfigured resources or whether the second timer is running.

In one subembodiment, the RRC layer of the first node verifies that the TA associated with the preconfigured resources is valid according to at least one of a change of an RSRP, or a mapping relation between an SSB and the preconfigured resources or whether the second timer is running.

In one subembodiment, when comparing with an RSRP of a last verification of a TA associated with the preconfigured resources, a value added to the RSRP does not exceed a first threshold, and a value reduced from the RSRP does not exceed a second threshold, and when the second timer is running, the TA associated with the preconfigured resources is valid.

In one subsidiary embodiment of the above subembodiment, the RSRP refers to an RSRP of a cell.

In one subsidiary embodiment of the above subembodiment, the RSRP refers to an RSRP of an SSB mapped by the preconfigured resource.

In one subembodiment, when comparing with an RSRP of a last verification of a TA associated with the preconfigured resources, a value added to the RSRP does not exceed a first threshold, and a value reduced from the

RSRP does not exceed a second threshold, no beam failure occurs in an SSB to which the preconfigured resources are mapped, and when the second timer is running, the TA associated with the preconfigured resources is valid.

In one subembodiment, when no beam failure occurs in an SSB to which the preconfigured resources are mapped, and when the second timer is running, the TA associated with the preconfigured resources is valid.

In one embodiment, the second timer is used for the second-type SDT procedure.

In one embodiment, the second timer is running and the second timer is effectively used for initiating the second-type SDT procedure.

In one embodiment, the second timer is used to determine whether the preconfigured resources can be used to transmit a packet in an RRC Inactive state, the packet being associated with one or more DRBs.

In one embodiment, the second timer's name includes timeAlignmentTimer.

In one embodiment, the second timer includes a CG-timeAlignmentTimer.

In one embodiment, the second timer includes an inactive-timeAlignmentTimer.

In one embodiment, the second timer includes an sdt-timeAlignmentTimer.

In one embodiment, the second timer includes a cg-timeAlignmentTimer.

In one embodiment, the second timer includes a ConfiguredGrant-timeAlignmentTimer.

In one embodiment, the second timer includes an sps-timeAlignmentTimer.

In one embodiment, the second timer includes a pur-timeAlignmentTimer.

In one embodiment, the second timer includes a cs-timeAlignmentTimer.

In one embodiment, the second timer includes an icg-timeAlignmentTimer.

In one embodiment, when the second timer is running, if a PUSCH is transmitted on the preconfigured resources, a PDCCH is scrambled by a first RNTI.

In one subembodiment, the first RNTI is a Cell-Radio Network Temporary Identifier (C-RNTI).

In one subembodiment, the first RNTI is only used for transmission on the preconfigured resources.

In one subembodiment, the first RNTI is used for an SDT procedure.

In one embodiment, whether the first buffer is flushed at the first time is determined according at least to whether the second timer is running at the first time.

In one embodiment, the action of determining whether the first buffer is flushed at the first time according at least to whether the second timer is running comprises:

not flushing the first buffer at the first time when the second timer is running;

flushing the first buffer at the first time when the second timer is not running;

In one embodiment, the action of determining whether the first buffer is flushed at the first time according at least to whether the second timer is running and the action of determining according to at least an RRC state whether a first buffer is flushed at a first time means: determining whether the first buffer is flushed at the first time according to at least the RRC state and whether the second timer is running;

In one embodiment, the action of determining whether the first buffer is flushed at the first time according to at least the RRC state and whether the second timer is running comprises: not flushing the first buffer at the first time when the second timer is running and an RRC Inactive state is kept from the action of receiving the first signaling till the first time.

In one embodiment, the action of determining whether the first buffer is flushed at the first time according to at least the RRC state and whether the second timer is running comprises: flushing the first buffer at the first time when the second timer is running and an RRC Connected state is kept from the action of receiving the first signaling till the first time.

In one embodiment, the action of determining whether the first buffer is flushed at the first time according to at least the RRC state and whether the second timer is running comprises: flushing the first buffer at the first time when the second timer isn't running and an RRC Connected state is kept from the action of receiving the first signaling till the first time.

In one embodiment, the action of determining whether the first buffer is flushed at the first time according to at least the RRC state and whether the second timer is running comprises: flushing the first buffer at the first time when the second timer isn't running and an RRC Inactive state is kept from the action of receiving the first signaling till the first time.

In one embodiment, the phrase that the second timer is different from the first timer comprises: the first timer and the second timer are not a same timer.

In one embodiment, the phrase that the second timer is different from the first timer comprises: an expiration value of the first timer and an expiration value of the second timer are different.

In one embodiment, the phrase that the second timer is different from the first timer comprises: the first timer and the second timer have different names.

In one embodiment, the phrase that the second timer is different from the first timer comprises: conditions for the first timer and the second timer being started, or being stopped or being expired are different.

In one embodiment, as the second timer is running, determine a second expiration value of the first timer according to the second timer as a response to the action of receiving a first message.

In one embodiment, the action of performing a second action comprises flushing the first buffer at the first time.

In one embodiment, the action of performing a second action comprises not flushing the first buffer at the first time.

In one embodiment, the dotted-line box F7.1 is optional.

In one embodiment, the dotted-line box F7.1 exists.

In one embodiment, the dotted-line box F7.1 does not exist.

In one embodiment, the dotted-line box F7.2 is optional.

In one embodiment, the dotted-line box F7.2 exists.

In one embodiment, the dotted-line box F7.2 does not exist.

In one embodiment, the dotted-line box F7.3 is optional.

In one embodiment, the dotted-line box F7.3 exists.

In one embodiment, the dotted-line box F7.3 does not exist.

In one embodiment, either of the dotted-line box F7.2 and the dotted-line box F7.3 does not exist.

In one subembodiment, the dotted-line box F7.2 exists while the dotted-line box F7.3 does not exist.

In one subembodiment, the dotted-line box F7.2 does not exist while the dotted-line box F7.3 exists.

### Embodiment 8

Embodiment 8 illustrates a schematic diagram of dropping starting a first timer upon reception of a first signaling according to one embodiment of the present application, as shown in FIG. 8. In FIG. 8, the horizontal axis indicates time; T8.1 and T8.2 are two instants of time in an ascending order chronologically.

In Embodiment 8, at the time T8.1, receive a first signaling, the first signaling being used to determine a first Timing Advance; as a response to the action of receiving the first signaling, drop starting the first timer; herein, a time interval from the action of receiving the first signaling till the first time is larger than or equal to a first expiration value of a first timer; not any message that indicates a Timing Advance is received from the action of receiving the first signaling till the first time.

In one embodiment, whether a first buffer is flushed at a first time is determined according to at least an RRC state.

In one embodiment, the time T8.2 includes the first time.

In one embodiment, from the action of receiving the first signaling till the first time the first timer is not started.

In one embodiment, a time interval between the T8.1 and the T8.2 is equal to the first expiration value.

### Embodiment 9

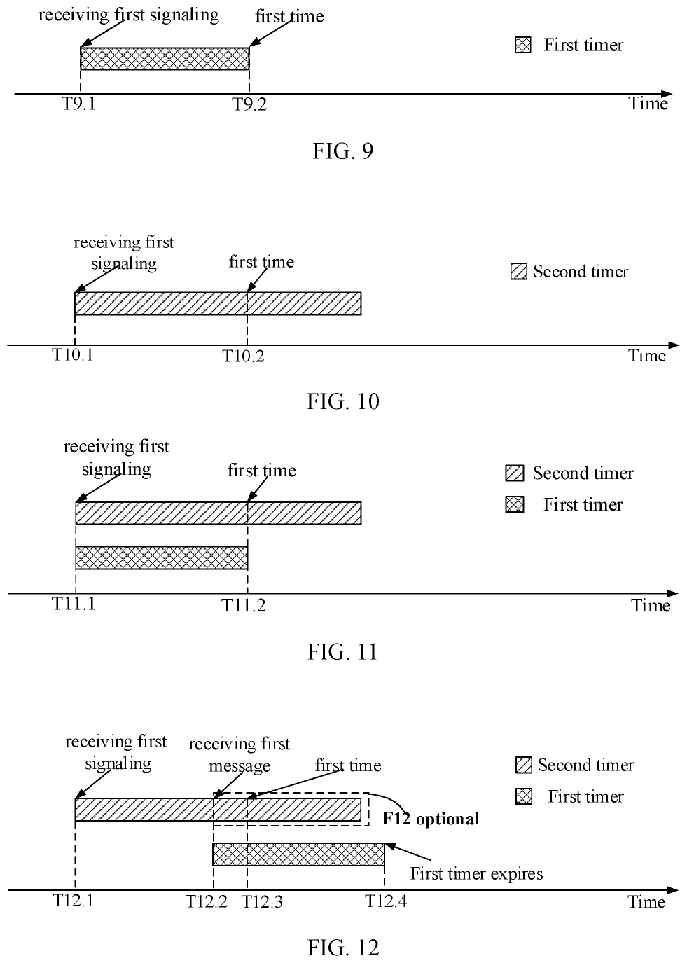

Embodiment 9 illustrates a schematic diagram of starting a first timer upon reception of a first signaling according to one embodiment of the present application, as shown in FIG. 9. In FIG. 9, the horizontal axis indicates time; T9.1 and T9.2 are two instants of time in an ascending order chronologically; the rectangular box filled with diamonds represents the time while a first timer is running

In Embodiment 9, at the time T9.1, receive a first signaling, the first signaling being used to determine a first Timing Advance; as a response to the action of receiving the first signaling, apply the first TA and initiate the first timer; herein, a time interval from the action of receiving the first signaling till the first time is larger than or equal to a first expiration value of a first timer; not any message that indicates a Timing Advance is received from the action of receiving the first signaling till the first time; the time while the first timer is running from the action of receiving the first signaling till the first time reaches the first expiration value of the first timer.

In one embodiment, whether a first buffer is flushed at a first time is determined according to at least an RRC state.

In one embodiment, the time T9.2 includes the first time.

In one embodiment, at the first time, the first timer is expired.

In one embodiment, before the first time, the first timer is expired.

In one embodiment, a time interval between the T9.1 and the T9.2 is equal to the first expiration value.

In one embodiment, an RRC Inactive state is kept from the action of receiving the first signaling till the first time.

In one embodiment, the first buffer is not flushed when the first timer is expired.

### Embodiment 10

Embodiment 10 illustrates a schematic diagram of starting a second timer upon reception of a first signaling according to one embodiment of the present application, as shown in FIG. 10. In FIG. 10, the horizontal axis indicates time; T10.1 and T10.2 are two instants of time in an ascending order chronologically; the rectangular box filled with slashes represents the running time of a second timer.

In Embodiment 10, at the T10.1, receive a first signaling, the first signaling being used to determine a first Timing Advance; as a response to the action of receiving the first signaling, drop starting the first timer; as a response to the action of receiving the first signaling, initiate a second timer; herein, a time interval from the action of receiving the first signaling till the first time is larger than or equal to a first expiration value of a first timer; not any message that indicates a Timing Advance is received from the action of receiving the first signaling till the first time; the second timer is different from the first timer.

In one embodiment, whether a first buffer is flushed at a first time is determined according to at least an RRC state.

In one embodiment, whether the first buffer is flushed at the first time is determined according at least to whether the second timer is running.

In one embodiment, the time T10.2 includes the first time.

In one embodiment, from the action of receiving the first signaling till the first time the first timer is not started.

In one embodiment, at the T10.2, the second timer is running.

In one embodiment, at the T10.2, the second timer isn't running.

In one embodiment, a time interval between the T10.1 and the T10.2 is equal to the first expiration value.

### Embodiment 11

Embodiment 11 illustrates a schematic diagram of starting a first timer and a second timer upon reception of a first signaling according to one embodiment of the present application, as shown in FIG. 11. In FIG. 11, the horizontal axis indicates time; T11.1 and T11.2 are two instants of time in an ascending order chronologically; the rectangular box filled with diamonds represents the running time of a first timer, and the rectangular box filled with slashes represents the running time of a second timer.

In Embodiment 11, at the T11.1, receive a first signaling, the first signaling being used to determine a first Timing Advance; as a response to the action of receiving the first signaling, apply the first TA and initiate the first timer; as a response to the action of receiving the first signaling, initiate the second timer; herein, a time interval from the action of receiving the first signaling till the first time is larger than or equal to a first expiration value of a first timer; not any message that indicates a Timing Advance is received from the action of receiving the first signaling till the first time; the time while the first timer is running from the action of receiving the first signaling till the first time reaches the first expiration value of the first timer; the second timer is different from the first timer.

In one embodiment, whether a first buffer is flushed at a first time is determined according to at least an RRC state.

In one embodiment, whether the first buffer is flushed at the first time is determined according at least to whether the second timer is running.

In one embodiment, the time T11.2 includes the first time.

In one embodiment, at the first time, the first timer is expired.

In one embodiment, before the first time, the first timer is expired.

In one embodiment, at the T11.2, the second timer is running.

In one embodiment, at the T11.2, the second timer isn't running.

In one embodiment, a time interval between the T11.1 and the T11.2 is equal to the first expiration value.

### Embodiment 12

Embodiment 12 illustrates a schematic diagram of starting a first timer upon reception of a first message according to one embodiment of the present application, as shown in FIG. 12. In FIG. 12, the horizontal axis indicates time; T12.1, T12.2, T12.3 and T12.4 are four instants of time in an ascending order chronologically; the rectangular box filled with diamonds represents the time while a first timer is running, and the rectangular box filled with slashes represents the time while a second timer is running.

In Embodiment 12, at the T12.1, receive a first signaling, the first signaling being used to determine a first Timing Advance; as a response to the action of receiving the first signaling, drop starting the first timer; as a response to the action of receiving the first signaling, initiate a second timer; at the T12.2, receive a first message; as a response of the action of receiving the first message, initiate the first timer; herein, a time interval from the action of receiving the first signaling till the first time is larger than or equal to a first expiration value of a first timer; not any message that indicates a Timing Advance is received from the action of receiving the first signaling till the first time; the second timer is different from the first timer; the first message is used for transition of the RRC state.

In one embodiment, whether a first buffer is flushed at a first time is determined according to at least an RRC state.

In one embodiment, whether the first buffer is flushed at the first time is determined according at least to whether the second timer is running.

In one embodiment, from the action of receiving the first signaling till the first time the first timer is started.

In one embodiment, at the first time, the first timer is running.

In one embodiment, the time T12.3 includes the first time.

In one embodiment, at the T12.4, the first timer is expired.

In one embodiment, at the T12.4, the second timer is running.

In one embodiment, at the T12.4, the second timer isn't running.

In one embodiment, a time interval between the T12.1 and the T12.3 is equal to the first expiration value.

In one embodiment, a time interval between the T12.2 and the T12.4 is equal to the first expiration value.

In one embodiment, a time interval between the T12.2 and the T12.4 is equal to the second expiration value.

In one embodiment, the dotted-line box F12 is optional.

In one embodiment, a termination time of the second timer in the dotted-line box F12 is earlier than the T12.4.

In one embodiment, a termination time of the second timer in the dotted-line box F12 is later than the T12.4.

In one embodiment, a termination time of the second timer in the dotted-line box F12 is equal to the T12.4.

### Embodiment 13

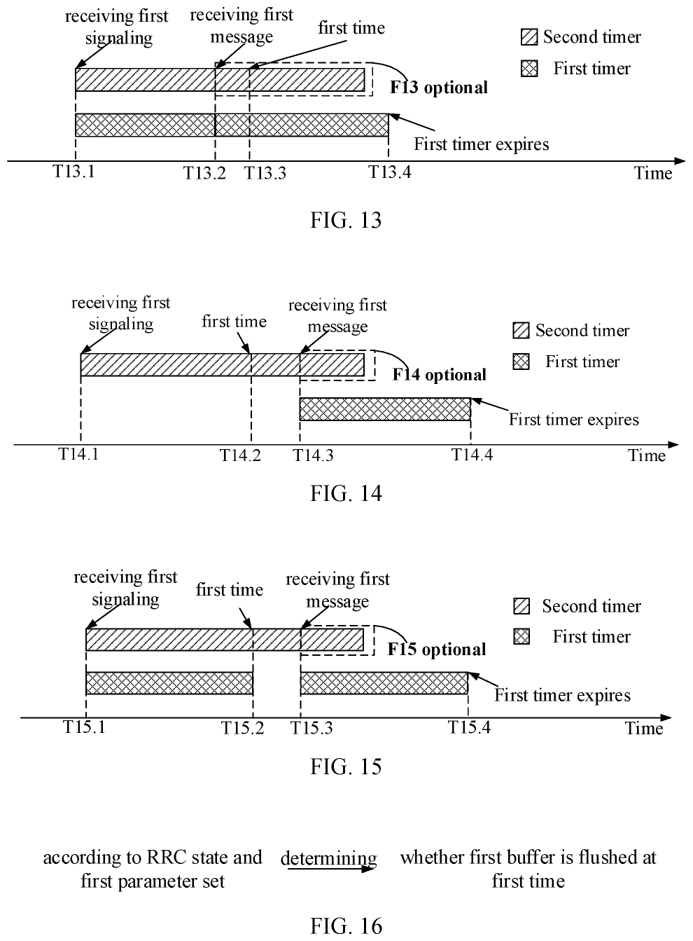

Embodiment 13 illustrates a schematic diagram of starting a first timer upon reception of a first message according to another embodiment of the present application, as shown in FIG. 13. In FIG. 13, the horizontal axis indicates time; T13.1, T13.2, T13.3 and T13.4 are four instants of time in an ascending order chronologically; the rectangular box filled with diamonds represents the running time of a first timer, and the rectangular box filled with slashes represents the running time of a second timer.

In Embodiment 13, at the T13.1, receive a first signaling, the first signaling being used to determine a first Timing Advance; as a response to the action of receiving the first signaling, apply the first TA and initiate the first timer; as a response to the action of receiving the first signaling, initiate the second timer; at the T13.2, receive a first message; as a response to the action of receiving the first message, initiate the first timer; determine according to at least an RRC state whether a first buffer is flushed at the first time; herein, a time interval from the action of receiving the first signaling till the first time is larger than or equal to a first expiration value of a first timer; not any message that indicates a Timing Advance is received from the action of receiving the first signaling till the first time; the time while the first timer is running from the action of receiving the first signaling till the first time reaches the first expiration value of the first timer; the second timer is different from the first timer; the first message is used for transition of the RRC state.

In one embodiment, whether a first buffer is flushed at a first time is determined according to at least an RRC state.

In one embodiment, whether the first buffer is flushed at the first time is determined according at least to whether the second timer is running.

In one embodiment, at the first time, the first timer is running.

In one embodiment, the time T13.3 includes the first time.

In one embodiment, at the T13.4, the first timer is expired.

In one embodiment, at the T13.4, the second timer is running.

In one embodiment, at the T13.4, the second timer isn't running.

In one embodiment, a time interval between the T13.1 and the T13.3 is equal to the first expiration value.

In one embodiment, a time interval between the T13.2 and the T13.4 is equal to the first expiration value.

In one embodiment, a time interval between the T13.2 and the T13.4 is equal to the second expiration value.

In one embodiment, the dotted-line box F13 is optional.

In one embodiment, a termination time of the second timer in the dotted-line box F13 is earlier than the T13.4.

In one embodiment, a termination time of the second timer in the dotted-line box F13 is later than the T13.4.

In one embodiment, a termination time of the second timer in the dotted-line box F13 is equal to the T13.4.

### Embodiment 14

Embodiment 14 illustrates a schematic diagram of starting a first timer upon reception of a first message according to another embodiment of the present application, as shown in FIG. 14. In FIG. 14, the horizontal axis indicates time; T14.1, T14.2, T14.3 and T14.4 are four instants of time in an ascending order chronologically; the rectangular box filled with diamonds represents the time while a first timer is running, and the rectangular box filled with slashes represents the time while a second timer is running.

In Embodiment 14, at the T14.1, receive a first signaling, the first signaling being used to determine a first Timing Advance; as a response to the action of receiving the first signaling, drop starting the first timer; as a response to the action of receiving the first signaling, initiate a second timer; at the T14.3, receive a first message; as a response of the action of receiving the first message, initiate the first timer; herein, a time interval from the action of receiving the first signaling till the first time is larger than or equal to a first expiration value of a first timer; not any message that indicates a Timing Advance is received from the action of receiving the first signaling till the first time; the second timer is different from the first timer; the first message is used for transition of the RRC state.

In one embodiment, whether a first buffer is flushed at a first time is determined according to at least an RRC state.

In one embodiment, whether the first buffer is flushed at the first time is determined according at least to whether the second timer is running.

In one embodiment, the time T14.3 includes the first time.

In one embodiment, at the T14.4, the first timer is expired.

In one embodiment, at the T14.4, the second timer is running.

In one embodiment, at the T14.4, the second timer isn't running.

In one embodiment, a time interval between the T14.1 and the T14.2 is equal to the first expiration value.

In one embodiment, a time interval between the T14.3 and the T14.4 is equal to the first expiration value.

In one embodiment, a time interval between the T14.3 and the T14.4 is equal to the second expiration value.

In one embodiment, the dotted-line box F14 is optional.

In one embodiment, a termination time of the second timer in the dotted-line box F14 is earlier than the T14.4.

In one embodiment, a termination time of the second timer in the dotted-line box F14 is later than the T14.4.

In one embodiment, a termination time of the second timer in the dotted-line box F14 is equal to the T14.4.

### Embodiment 15

Embodiment 15 illustrates a schematic diagram of starting a first timer upon reception of a first message according to another embodiment of the present application, as shown in FIG. 15. In FIG. 15, the horizontal axis indicates time; T15.1, T15.2, T15.3 and T15.4 are four instants of time in an ascending order chronologically; the rectangular box filled with diamonds represents the running time of a first timer, and the rectangular box filled with slashes represents the running time of a second timer.

In Embodiment 15, at the T15.1, receive a first signaling, the first signaling being used to determine a first Timing Advance; as a response to the action of receiving the first signaling, apply the first TA and initiate the first timer; as a response to the action of receiving the first signaling, initiate the second timer; determine according to at least an RRC state whether a first buffer is flushed at the first time; at the T15.3, receive a first message; as a response to the action of receiving the first message, initiate the first timer; herein, a time interval from the action of receiving the first signaling till the first time is larger than or equal to a first expiration value of a first timer; not any message that indicates a Timing Advance is received from the action of receiving the first signaling till the first time; the time while the first timer is running from the action of receiving the first signaling till the first time reaches the first expiration value of the first timer; the second timer is different from the first timer; the first message is used for transition of the RRC state.

In one embodiment, whether a first buffer is flushed at a first time is determined according to at least an RRC state.

In one embodiment, whether the first buffer is flushed at the first time is determined according at least to whether the second timer is running.

In one embodiment, the time T15.2 includes the first time.

In one embodiment, at the T15.4, the first timer is expired.

In one embodiment, at the T15.4, the second timer is running.

In one embodiment, at the T15.4, the second timer isn't running.

In one embodiment, a time interval between the T15.1 and the T15.2 is equal to the first expiration value.

In one embodiment, a time interval between the T15.3 and the T15.4 is equal to the first expiration value.

In one embodiment, a time interval between the T15.3 and the T15.4 is equal to the second expiration value.

In one embodiment, the dotted-line box F15 is optional.

In one embodiment, a termination time of the second timer in the dotted-line box F15 is earlier than the T15.4.

In one embodiment, a termination time of the second timer in the dotted-line box F15 is later than the T15.4.

In one embodiment, a termination time of the second timer in the dotted-line box F15 is equal to the T15.4.

### Embodiment 16

Embodiment 16 illustrates a schematic diagram of determining whether a first buffer is flushed at a first time according to an RRC state and a first parameter set according to one embodiment of the present application, as shown in FIG. 16.

In Embodiment 16, the action of determining according to at least an RRC state whether a first buffer is flushed at a first time comprises: determining whether the first buffer is flushed at the first time according to the RRC state and a first parameter set.

In one subembodiment, the first parameter set comprises a positive integer number of parameter(s).

In one subembodiment, a parameter in the first parameter set comprises whether the second timer in the present application is running.

In one embodiment, the action of determining whether the first buffer is flushed at the first time according to the RRC state and a first parameter set comprises:

flushing the first buffer at the first time, when an RRC Connected state is kept from the action of receiving the first signaling till the first time and the first parameter set is fulfilled;

not flushing the first buffer at the first time, when an RRC Inactive state is kept from the action of receiving the first signaling till the first time and the first parameter set is fulfilled.

In one embodiment, the action of determining whether the first buffer is flushed at the first time according to the RRC state and a first parameter set comprises: flushing the first buffer at the first time when an RRC Connected state is kept from the action of receiving a first signaling till the first time.

In one embodiment, the action of determining whether the first buffer is flushed at the first time according to the RRC state and a first parameter set comprises: not flushing the first buffer at the first time when an RRC Inactive state is kept from the action of receiving a first signaling till the first time and the first parameter set is fulfilled.

In one embodiment, the action of determining whether the first buffer is flushed at the first time according to the RRC state and a first parameter set comprises: flushing the first buffer at the first time when an RRC Inactive state is kept from the action of receiving a first signaling till the first time and the first parameter set is unfulfilled.

In one embodiment, the action of determining whether the first buffer is flushed at the first time according to the RRC state and a first parameter set comprises: not flushing the first buffer at the first time when an RRC Inactive state is kept from the action of receiving a first signaling till the first time and the first parameter set is unfulfilled.

In one embodiment, the first parameter set comprises whether an SDT procedure is being performed.

In one subembodiment, when performing the SDT procedure, a condition in the first parameter set is satisfied.

In one subembodiment, the given timer being running is used to determine that the SDT procedure is being performed.

In one subembodiment, the one or more DRBs being resumed in an RRC_INACTIVE state is used to determine that the SDT procedure is being performed.

In one subembodiment, a PDCCH in an RRC_INACTIVE state listening over scrambling of an RNTI associated with the preconfigured resources is used to determine that the SDT procedure is being performed.

In one subembodiment, a PDCCH in an RRC_INACTIVE state listening over scrambling of a C-RNTI is used to determine that the SDT procedure is being performed.

In one subembodiment, performing the first-type SDT is used to determine that the SDT procedure is being performed.

In one subembodiment, performing the second-type SDT is used to determine that the SDT procedure is being performed.

In one embodiment, the first parameter set comprises whether the first timer is running.

In one subembodiment, when the first timer is running, a condition in the first parameter set is satisfied.

In one embodiment, the first parameter set comprises whether the second timer is running.

In one subembodiment, when the second timer is running, a condition in the first parameter set is satisfied.

In one embodiment, the first parameter set comprises K1 condition(s), K1 being a positive integer.

In one subembodiment, when each of the K1 condition(s) in the first parameter set is satisfied, the first parameter set is satisfied.

In one subembodiment, when at least one of the K1 condition(s) in the first parameter set is not satisfied, the first parameter set is not satisfied.

### Embodiment 17

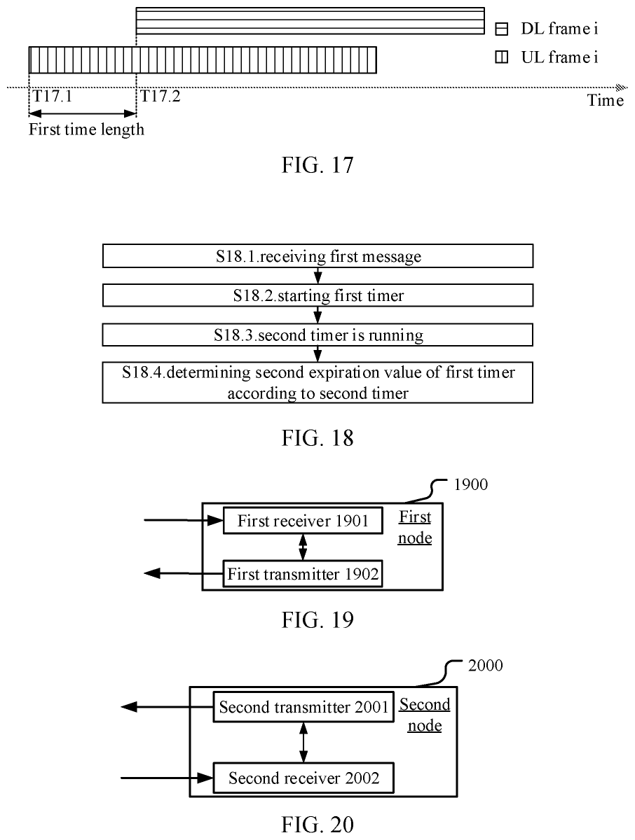

Embodiment 17 illustrates a schematic diagram of a timing relation between uplink and downlink being linked to a first Timing Advance according to one embodiment of the present application, as shown in FIG. 17. In FIG. 17, the rectangular box filled with horizontal solid lines represents a downlink frame i, while the rectangular box filled with vertical solid lines represents an uplink frame i; T17.1 and T17.2 are two times in an ascending order chronologically; a start time of the uplink frame i is T17.1, while a start time of the downlink frame i is T17.2; a time interval between the T17.1 and T17.2 is equal to a first time length.

In Embodiment 17, a timing relation between uplink and downlink is linked to the first Timing Advance.

In one embodiment, the i is a positive integer.

In one embodiment, the i identifies a frame number.

In one embodiment, the uplink frame i is a Frame.

In one embodiment, the uplink frame i is a Subframe.

In one embodiment, the downlink frame i is a Frame.

In one embodiment, the downlink frame i is a Subframe.

In one embodiment, the frame is comprised of 10 subframes.

In one embodiment, the frame is comprised of 2 half-frames with equal lengths, each of the half-frames comprising 5 subframes.

In one embodiment, a length of the frame is 10 ms.

In one embodiment, a length of the subframe is 1 ms.

In one embodiment, the first time length is related to the first Timing Advance.

In one embodiment, the first time length is equal to the first Timing Advance.

In one embodiment, the first time length is greater than the first Timing Advance.

In one embodiment, the first time length is less than the first Timing Advance.

In one embodiment, the first time length refers to the first Timing Advance.

In one embodiment, the first time length is determined by the first Timing Advance.

In one embodiment, the first time length is calculated according to the first Timing Advance.

In one embodiment, the first time length is equal to (N_{TA}+N_{TA,offset})T_{c}, where N_{TA} refers to the first Timing Advance, and N_{TA,offset} is either configured by n-TimingAdvanceOffset or determined by a UE.

In one embodiment, the first Timing Advance indicates an adjustment value of an uplink timing relative to the present uplink timing, the adjustment value being an integral multiple of 16·64·T_{c}/2^{μ}.

In one embodiment, a time interval between a start time of the first node transmitting the uplink frame i and a start time of the first node receiving the downlink frame i is equal to the first time length.

In one embodiment, for a MsgA transmission on a PUSCH, N_{TA} is equal to 0.

### Embodiment 18

Embodiment 18 illustrates a schematic diagram of determining a second expiration value of a first timer by a second timer according to one embodiment of the present application, as shown in FIG. 18.

In Embodiment 18, the first node receives a first message in step S18.1; and as a response to the action of receiving the first message, initiates the first timer in step S18.2; determines that a second timer is running in step S18.3; and when the second timer is running, determines a second expiration value of the first timer according to the second timer in step S18.4, as a response to the action of receiving the first message; where the first message is used for transition of the RRC state.

In one embodiment, the action of determining a second expiration value of the first timer according to the second timer means that the second expiration value of the first timer is related to the second timer.

In one embodiment, the action of determining a second expiration value of the first timer according to the second timer means that the second expiration value of the first timer is set to remaining time of the second timer.

In one subembodiment, a difference between the expiration value of the second timer and the current value of the second timer is used to determine the remaining time of the second timer.

In one subembodiment, the remaining time of the second timer means how long the second timer will be expired.

In one embodiment, the action of determining a second expiration value of the first timer according to the second timer means that the second expiration value of the first timer is set to a difference between the first expiration value of the first timer and the current value of the second timer.

In one subembodiment, the current value of the second timer is equal to the time for which the second timer has been running.

In one subembodiment, the current value of the second timer refers to timing of the second timer when the first timer is started.

In one embodiment, the action of determining a second expiration value of the first timer according to the second timer means that the second expiration value of the first timer is set to a smaller one between remaining time of the second timer and the first expiration value of the first timer.

In one embodiment, the action of determining a second expiration value of the first timer according to the second timer means that the second expiration value of the first timer is set to a greater one between remaining time of the second timer and the first expiration value of the first timer.

In one embodiment, the action of determining a second expiration value of the first timer according to the second timer means to calculate the second expiration value according to remaining time of the second timer, or a current value of the second timer, or the first expiration value of the first timer.

### Embodiment 19

Embodiment 19 illustrates a structure block diagram of a processing device used in a first node according to one embodiment of the present application; as shown in FIG. 19. In FIG. 19, a processing device 1900 in the first node is comprised of a first receiver 1901 and a first transmitter 1902.

The first receiver 1901 receives a first signaling, the first signaling being used to determine a first Timing Advance; and determines according to at least an RRC state whether a first buffer is flushed at a first time.

In Embodiment 19, a time interval from the action of receiving the first signaling till the first time is larger than or equal to a first expiration value of a first timer; not any message that indicates a Timing Advance is received from the action of receiving the first signaling till the first time; the action of determining according to at least an RRC state whether a first buffer is flushed at a first time comprises: flushing the first buffer at the first time when an RRC Connected state is kept from the action of receiving the first signaling till the first time; or not flushing the first buffer at the first time when an RRC Inactive state is kept from the action of receiving the first signaling till the first time.

In one embodiment, as a response to the action of receiving the first signaling, the first receiver 1901 applies the first Timing Advance, and initiates the first timer; herein, the time while the first timer is running from the action of receiving the first signaling till the first time reaches the first expiration value of the first timer.

In one embodiment, the first receiver 1901, as a response to the action of receiving a first signaling, drops starting the first timer.

In one embodiment, the first receiver 1901 receives a first message; and, as a response to the action of receiving a first message, initiates the first timer; herein, the first message is used for transiting the RRC state.

In one embodiment, the first receiver 1901, as a response to the action of receiving a first signaling, initiates a second timer; and determines whether the first buffer is flushed at the first time according at least to whether the second timer is running; herein, the second timer is different from the first timer.

In one embodiment, the first receiver 1901, as the second timer is running, determines a second expiration value of the first timer according to the second timer as a response to the action of receiving a first message.

In one embodiment, a first transmitter 1902 transmits a second message set in the RRC Inactive state; herein, the second message set triggers the first signaling.

In one embodiment, the first receiver 1901 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1901 comprises the antenna 452, the receiver 454, the multi-antenna receiving processor 458 and the receiving processor 456 in FIG. 4 of the present application.

In one embodiment, the first receiver 1901 comprises the antenna 452, the receiver 454 and the receiving processor 456 in FIG. 4 of the present application.

In one embodiment, the first transmitter 1902 comprises the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1902 comprises the antenna 452, the transmitter 454, the multi-antenna transmitting processor 457 and the transmitting processor 468 in FIG. 4 of the present application.

In one embodiment, the first transmitter 1902 comprises the antenna 452, the transmitter 454 and the transmitting processor 468 in FIG. 4 of the present application.

### Embodiment 20

Embodiment 20 illustrates a structure block diagram of a processing device used in a second node according to one embodiment of the present application; as shown in FIG. 20. In FIG. 20, a processing device 2000 in a second node comprises a second transmitter 2001 and a second receiver 2002.

The second transmitter 2001 transmits a first signaling, the first signaling being used to determine a first Timing Advance.

In Embodiment 20, whether a first buffer is flushed at a first time is determined according to at least an RRC state; a time interval from the first signaling being received till the first time is larger than or equal to a first expiration value of a first timer; not any message that indicates a Timing Advance is received from the first signaling being received till the first time; the phrase that whether a first buffer is flushed at a first time is determined according to at least an RRC state comprises:

the first buffer being flushed at the first time when an RRC Connected state is kept from the first signaling being received till the first time; or

the first buffer not being flushed at the first time when an RRC Inactive state is kept from the first signaling being received till the first time.

In one embodiment, whether a first buffer is flushed at a first time by the first node is determined by the first node according to at least an RRC state.

In one embodiment, as a response to the first signaling being received, the first Timing Advance is applied, and the first timer is started; where the time while the first timer is running from the action of receiving the first signaling till the first time reaches the first expiration value of the first timer.

In one embodiment, as a response to the first signaling being received, the first timer is dropped for starting.

In one embodiment, as a response to the first signaling being received, the first timer is dropped by the first node for starting.

In one embodiment, the second transmitter 2001 transmits a first message; herein, as a response to the first message being received, the first timer is started; the first message is used for transition of the RRC state.

In one embodiment, as a response to the first message being received, the first timer is started by the first node.

In one embodiment, as a response to the first signaling being received, a second timer is started; herein, whether the first buffer is flushed at the first time is determined according at least to whether the second timer is running; the second timer is different from the first timer.

In one embodiment, as a response to the first signaling being received, the second timer is started by the first node.

In one embodiment, as the second timer is running, a second expiration value of the first timer is determined according to the second timer as a response to the first message being received.

In one embodiment, a second expiration value of the first timer is determined by the first node according to the second timer.

In one embodiment, the second receiver 2002 receives a second message set; herein, the second message set triggers the first signaling; the second message set is transmitted in the RRC Inactive state.

In one embodiment, the second message set is transmitted by the first node in the RRC Inactive state.

In one embodiment, the second transmitter 2001 comprises the antenna 420, the transmitter 418, the multi-antenna transmitting processor 471, the transmitting processor 416, the controller/processor 475 and the memory 476 in FIG. 4 of the present application.

In one embodiment, the second transmitter 2001 comprises the antenna 420, the transmitter 418, the multi-antenna transmitting processor 471 and the transmitting processor 416 in FIG. 4 of the present application.

In one embodiment, the second transmitter 2001 comprises the antenna 420, the transmitter 418 and the transmitting processor 416 in FIG. 4 of the present application.

In one embodiment, the second receiver 2002 comprises the antenna 420, the receiver 418, the multi-antenna receiving processor 472, the receiving processor 470, the controller/processor 475 and the memory 476 in FIG. 4 of the present application.

In one embodiment, the second receiver 2002 comprises the antenna 420, the receiver 418, the multi-antenna receiving processor 472 and the receiving processor 470 in FIG. 4 of the present application.

In one embodiment, the second receiver 2002 comprises the antenna 420, the receiver 418 and the receiving processor 470 in FIG. 4 of the present application.

### Embodiment 21

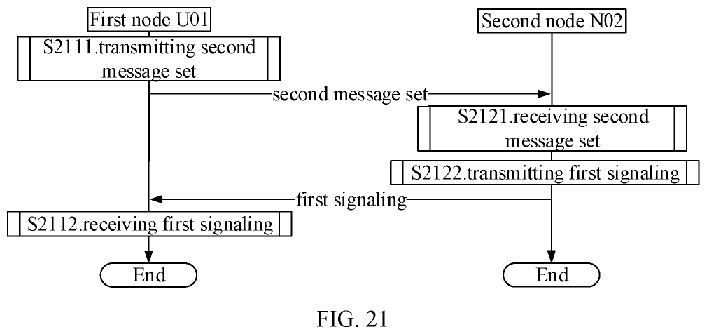

Embodiment 21 illustrates a flowchart of radio signal transmission in which a second message set triggers a first signaling according to one embodiment of the present application, as shown in FIG. 21.

The first node U01 transmits a second message set in the RRC Inactive state in step S2111; and receives a first signaling in step S2112.

The second node NO2 receives the first second message set in step S2121; and transmits the first signaling in step S2122.

In Embodiment 21, the first signaling is used to determine a first Timing Advance; the second message set triggers the first signaling.

In one embodiment, the action of transmitting a second message set in the RRC Inactive state comprises:

transmitting the second message set when the first node is in the RRC Inactive state.

In one embodiment, the action of transmitting a second message set in the RRC Inactive state comprises: the first node is in the RRC Inactive state when transmitting the second message set.

In one embodiment, the second message set is used for an SDT procedure.

In one embodiment, transmit a second message set in the RRC Inactive state and initiate the given timer.

In one embodiment, in the RRC inactive state, when initiating an SDT procedure, initiate the given timer, set the content in the second message set and transmit the second message set.

In one embodiment, the second message set does not comprise a Common Control Channel (CCCH) Service Data Unit (SDU).

In one embodiment, the second message set is transmitted via an air interface.

In one embodiment, the second message set is transmitted via an antenna port.

In one embodiment, the second message set is transmitted via an upper layer signaling.

In one embodiment, the second message set is transmitted via a higher layer signaling.

In one embodiment, the second message set comprises an Uplink (UL) signal.

In one embodiment, the second message set comprises a Sidelink (SL) signal.

In one embodiment, the second message set comprises all or part of an upper layer signaling.

In one embodiment, the second message set comprises all or part of a higher layer signaling.

In one embodiment, a Signaling Radio Bearer (SRB) for the second message set includes SRB0.

In one embodiment, the second message set is transmitted on an Uplink-Sharing Channel (UL-SCH).

In one embodiment, the second message set comprises an Msg3.

In one embodiment, the second message set comprises part of an MsgA.

In one embodiment, the second message set comprises a CCCH message.

In one embodiment, the second message set comprises a CCCH SDU.

In one embodiment, the second message set comprises a CCCH SDU that comprises the RRC message.

In one embodiment, the second message set comprises a Medium Access Control (MAC) Control Element (CE).

In one embodiment, the second message set comprises a MAC PDU.

In one embodiment, the second message set comprises a MAC subheader.

In one embodiment, the second message set comprises a C-RNTI MAC CE.

In one embodiment, the second message set comprises data of DRB.

In one subembodiment, the second message set comprises a Buffer Status Report (BSR).

In one embodiment, the second message set comprises Padding bits.

In one embodiment, the second message set comprises an RRC message.

In one embodiment, the second message set comprises an RRC message, the RRC message's name including RRCResumeRequest message.

In one embodiment, the second message set comprises an RRC message, the RRC message's name including RRCResumeRequest message.

In one embodiment, the second message set comprises an RRC message, the RRC message's name including RRCEarlyDataRequest message.

In one embodiment, names of the second message set include at least one of RRC or Connection or Resume, or sdt or idt, or Inactive or Small, Data, Transmission or Request.

In one embodiment, the phrase that the second message set triggers the first signaling comprises: the first signaling is a response to the second message set.

In one embodiment, the phrase that the second message set triggers the first signaling comprises: the second message set is used for initiating an SDT procedure, and receiving the first signaling in the SDT procedure.

In one embodiment, the phrase that the second message set triggers the first signaling comprises: the first signaling is received after the second message set is transmitted.

In one embodiment, the phrase that the second message set triggers the first signaling comprises: the first signaling carries an acknowledgment message for the second message set.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The

UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first signaling, the first signaling being used to determine a first Timing Advance;
and determining according to at least an RRC state whether a first buffer is flushed at a first time;
wherein a time interval from the action of receiving the first signaling till the first time is larger than or equal to a first expiration value of a first timer; not any message that indicates a Timing Advance is received from the action of receiving the first signaling till the first time; the action of determining according to at least an RRC state whether a first buffer is flushed at a first time comprises:
flushing the first buffer at the first time when an RRC Connected state is kept from the action of receiving the first signaling till the first time; or
not flushing the first buffer at the first time when an RRC Inactive state is kept from the action of receiving the first signaling till the first time.

2. The first node according to claim 1, comprising:
the first receiver, as a response to the action of receiving the first signaling, applying the first Timing Advance, and starting the first timer;
wherein the time while the first timer is running from the action of receiving the first signaling till the first time reaches the first expiration value of the first timer.

3. The first node according to claim 2, wherein the first signaling is received in an SDT procedure, the SDT procedure including transmitting a small packet in an RRC Inactive state; the SDT procedure is a second-type SDT, and a first uplink PUSCH for the second-type SDT is transmitted through preconfigured resources.

4. The first node according to claim 3, wherein the first signaling comprises a MAC RAR, or, the first signaling comprises a fallbackRAR, or, the first signaling comprises a successRAR.

5. The first node according to claim 2, wherein the first signaling is received in the RRC Connected state.

6. The first node according to claim 5, wherein the first signaling comprises a Timing Advance Command MAC CE, or, the first signaling comprises an Absolute Timing Advance Command MAC CE.

7. The first node according to claim 1, comprising:
the first receiver, as a response to the action of receiving a first signaling, dropping starting the first timer.

8. The first node according to claim 1, comprising:
the first receiver, receiving a first message; and, as a response to the action of receiving a first message, starting the first timer;
wherein the first message is used for transform of the RRC state.

9. The first node according to claim 1, comprising:
the first receiver, as a response to the action of receiving a first signaling, starting a second timer; and
determining whether the first buffer is flushed at the first time according at least to whether the second timer is running;
wherein the second timer is different from the first timer.

10. The first node according to claim 5, comprising:
the first receiver, as the second timer is running, determining a second expiration value of the first timer according to the second timer as a response to the action of receiving a first message.

11. The first node according to claim 1, comprising:
a first transmitter, transmitting a second message set in the RRC Inactive state;
wherein the second message set triggers the first signaling.

12. A method in a first node for wireless communications, comprising:
receiving a first signaling, the first signaling being used to determine a first Timing Advance; and
determining according to at least an RRC state whether a first buffer is flushed at a first time;
wherein a time interval from the action of receiving the first signaling till the first time is larger than or equal to a first expiration value of a first timer; not any message that indicates a Timing Advance is received from the action of receiving the first signaling till the first time; the action of determining according to at least an RRC state whether a first buffer is flushed at a first time comprises:
flushing the first buffer at the first time when an RRC Connected state is kept from the action of receiving the first signaling till the first time; or
not flushing the first buffer at the first time when an RRC Inactive state is kept from the action of receiving the first signaling till the first time.

13. A second node for wireless communications, comprising:
a second transmitter, transmitting a first signaling, the first signaling being used to determine a first Timing Advance;
wherein whether a first buffer is flushed at a first time is determined according to at least an RRC state; a time interval from the first signaling being received till the first time is larger than or equal to a first expiration value of a first timer; not any message that indicates a Timing Advance is received from the first signaling being received till the first time; the phrase that whether a first buffer is flushed at a first time is determined according to at least an RRC state comprises:
the first buffer being flushed at the first time when an RRC Connected state is kept from the first signaling being received till the first time; or
the first buffer not being flushed at the first time when an RRC Inactive state is kept from the first signaling being received till the first time.

14. The second node according to claim 13, wherein as a response to the first signaling being received, the first Timing Advance is applied, and the first timer is initiated; wherein the time while the first timer is running from the action of receiving the first signaling till the first time reaches the first expiration value of the first timer.

15. The second node according to claim 14, wherein the first signaling is received in an SDT procedure, the SDT procedure including transmitting a small packet in an RRC Inactive state; the SDT procedure is a second-type SDT, and a first uplink PUSCH for the second-type SDT is transmitted through preconfigured resources.

16. The second node according to claim 15, wherein the first signaling comprises a MAC RAR, or, the first signaling comprises a fallbackRAR, or, the first signaling comprises a successRAR.

17. The second node according to claim 14, wherein the first signaling is received in the RRC Connected state; the first signaling comprises a Timing Advance Command MAC CE, or, the first signaling comprises an Absolute Timing Advance Command MAC CE.

18. The second node according to claim 13, comprising:
the second transmitter, transmitting a first message; wherein as a response to the first message being received, the first timer is initiated; the first message is used for transform of the RRC state.

19. The second node according to claim 13, comprising: a second receiver, receiving a second message set; wherein the second message set triggers the first signaling; the second message set is transmitted in the RRC Inactive state.

20. A method in a second node for wireless communications, comprising:
transmitting a first signaling, the first signaling being used to determine a first Timing Advance;
wherein whether a first buffer is flushed at a first time is determined according to at least an RRC state; a time interval from the first signaling being received till the first time is larger than or equal to a first expiration value of a first timer; not any message that indicates a Timing Advance is received from the first signaling being received till the first time; the phrase that whether a first buffer is flushed at a first time is determined according to at least an RRC state comprises:
the first buffer being flushed at the first time when an RRC Connected state is kept from the first signaling being received till the first time; or
the first buffer not being flushed at the first time when an RRC Inactive state is kept from the first signaling being received till the first time.
